(19) United States
(12) Patent Application Publication
(10) Pub. No.: US 2014/0085274 A1
(43) Pub. Date: Mar. 27, 2014

(54) DISPLAY DEVICES AND DISPLAY ADDRESSING METHODS UTILIZING VARIABLE ROW LOADING TIMES

(71) Applicant: PIXTRONIX, INC., San Diego, CA (US)

(72) Inventor: Stephen R. Lewis, Reading, MA (US)

(73) Assignee: Pixtronix, Inc., San Diego, CA (US)

(21) Appl. No.: 13/627,614

(22) Filed: Sep. 26, 2012

(51) Int. Cl. G06F 3/038

(52) U.S. Cl. 345/204

(57) ABSTRACT

An apparatus includes an array of pixels formed on a substrate, a set of data drivers, and a controller. The set of data drivers is configured to output data signals to the pixels. The data signals are representative of subsequent states of each respective pixel. The controller is configured to allocate a first period of time and a second period of time for the data drivers. The first period of time is used to load data into the first set of the pixels, which are located within a first distance from the data drivers. The second period of time is used to load data into a second set of pixels, which are located at distance from the data drivers that is greater than the first distance. The second period of time is longer than the first period of time.

### TECHNICAL FIELD

This disclosure relates to display devices and methods for addressing such display devices.

### DESCRIPTION OF THE RELATED TECHNOLOGY

In order to display images on a digital display with a large number of colors and with reduced or no image artifacts, a digital display apparatus transitions its pixels between states a large number of times before forming a series of distinct image subframes for each image frame. The resulting time pressure is particularly acute in field sequential color displays, e.g., displays in which the separate color subframes (sometimes referred to as color subfields) are displayed in sequence, one color at a time. To display a given subframe, appropriate data must be loaded into pixels in each row in the display, commonly in a sequential fashion. This process is referred to as addressing. As the number of subframes grows, the amount of time utilized to address the pixels in the display quickly begins to limit the number and/or duration of the subframes used.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes an array of pixels formed on a substrate, a plurality of data drivers, and a controller. The plurality of data drivers are configured to output data signals to the pixels, wherein the data signals are representative of subsequent states of each respective pixel. The controller is configured to allocate a first period of time for the data drivers to load data into a first set of the pixels. The first set of the pixels is located within a first distance from the data drivers. The controller is further configured to allocate a second period of time for the data drivers to load data into a second set of the pixels. The pixels in the second set of the pixels are located at a distance from the data drivers that is greater than the first distance, and the second period of time is longer than the first period of time. In some implementations, the data signals output by the data drivers are applied to at least one thin film transistor associated with each of the pixels.

In some implementations, the array of pixels includes an array of transmissive light modulators, an array of reflective light modulators, or an array of light emitters. In some implementations, the array of pixels includes an array of microelectromechanical system (MEMS) based light modulators. In some of these implementations, the array of pixels includes an array of shutter based light modulators.

In some implementations, the first set of the pixels includes at least a first row of pixels and the second set of the pixels includes at least a second row of pixels. In some implementations, the controller can be configured to cause the data drivers to output data signals to the first set of the pixels for the first period of time and instruct the data drivers to output data signals to the second set of the pixels for the second period of time.

In some implementations, the apparatus includes a plurality of scan-line drivers configured to output write-enabling signals to the pixels. In such implementations, the controller is further configured to cause the scan-line drivers to output write-enabling signals to the second set of the pixels for a greater amount of time than the time for which write-enabling signals are output by the scan-line drivers to the first set of the pixels. In some implementations, the first distance is sufficiently short enough such that the data signals output by the data drivers reach the first set of the pixels before the write-enabling signals reach a pixel in the first set of the pixels furthest from the scan-line drivers, and the second set of pixels are located sufficiently far enough from the data drivers such that the data signals output by the data drivers first reach the second set of the pixels after the write-enabling signals reach a pixel in the second set of the pixels furthest from the scan-line drivers.

In some implementations, the controller is configured to individually allocate periods of time to each row of pixels located at distances from the data drivers that is greater than the first distance. In some other implementations, the controller is configured to allocate periods of time to row of pixels located at distances from the data drivers that is greater than the first distance in groups. In some such of such implementations, the controller can allocate increasing periods of time to each group of rows that is more distant from the data driver than the first distance. In some other implementations, the controller is configured to cause the data drivers to output data signals to the second set of the pixels by allocating a maximum data propagation time to pixels in all rows in which the amount of time it takes for a data signal to propagate to a row being addressed is greater than the amount of time it takes for a write-enabling signal to propagate to the end of that row. In some implementations, the first distance is substantially equal to the distance a data signal output by the data drivers travels in the amount of time it takes for a write enabling signal output by a write enabling driver to reach the end of a row of pixels.

In some implementations, the array of pixels include at least one of light modulators, electromechanical systems (EMS) devices and microelectromechanical systems (MEMS) devices. In some implementations, the light modulators comprise shutter-based light modulators. In some implementations, the apparatus further includes: a display module incorporating the array of pixels and the controller, a processor configured to process image data, and a memory device that is configured to communicate with the processor. In some implementations, the controller includes at least one of the processor and the memory device. In some implementations, the apparatus further includes a driver circuit configured to send at least one signal to the display module, and the processor is further configured to send at least a portion of the image data to the driver circuit. In some implementations, the apparatus further includes an image source module configured to send the image data to the processor, wherein the image source module includes at least one of a receiver, transceiver, and transmitter. In some implementations, the apparatus further includes an input device configured to receive input data and to communicate the input data to the processor.

Another innovative aspect of the subject matter described in this disclosure can be implemented in a method for displaying an image on a display. The method includes allocating a first period of time for a plurality of data drivers to load a first set of data into a first set of pixels. The first set of pixels is located within a first distance from the data drivers and the first set of data is indicative of subsequent states of the first set of pixels. The method also includes allocating a second period of time for the data drivers to load a second set of data into a second set of pixels. The pixels in the second set of pixels are located at a distance from the data drivers that is greater than the first distance, the second period of time is longer than the first period of time, and the second set of data is indicative of subsequent states of the second set of pixels. The plurality of data drivers are then caused to output data signals corresponding to the first and second sets of data to the first and second sets of pixels according to the allocated periods of time.

In some implementations, the array of pixels includes an array of electromechanical systems-based light modulators. In some implementations, the first set of pixels includes at least a first row of pixels and the second set of pixels includes at least a second set row of pixels. In some other implementations. In addition, in some implementations, the first distance is substantially equal to the distance a data signal output by the data drivers travels in the amount of time it takes for a write enabling signal output by a write enabling driver to reach the end of a row of pixels.

Another innovative aspect of the subject matter described in this disclosure can be implemented in a computer-readable storage medium having computer-executable instructions stored thereon, which when executed by a computer, cause the computer to form an image on the display. The instructions cause the computer to allocate a first period of time for a plurality of data drivers to load a first set of data into a first set of pixels. The first set of pixels is located within a first distance from the data drivers and the first set of data is indicative of subsequent states of the first set of pixels. The instructions also cause the computer to allocate a second period of time for the data drivers to load a second set of data into a second set of pixels. The pixels in the second set of pixels are located at a distance from the data drivers that is greater than the first distance, the second period of time is longer than the first period of time, and the second set of data is indicative of subsequent states of the second set of pixels. The plurality of data drivers are then caused to output data signals corresponding to the first and second sets of data to the first and second sets of pixels according to the allocated periods of time.

In some implementations, the array of pixels includes an array of electromechanical systems-based light modulators. In some implementations, the first set of pixels includes at least a first row of pixels and the second set of pixels includes at least a second set row of pixels. In some other implementations. In addition, in some implementations, the first distance is substantially equal to the distance a data signal output by the data drivers travels in the amount of time it takes for a write enabling signal output by a write enabling driver to reach the end of a row of pixels.

Details of one or more implementations of the subject matter described in this specification are set forth in the accompanying drawings and the description below. Although the examples provided in this summary are primarily described in terms of or EMS-based displays (including nanoelectromechancial systems (NEMS), microelectromechanical systems (MEMS) or larger-scale displays), the concepts provided herein may apply to other types of displays, such as liquid crystal (LCD) displays, organic light emitting diode (OLED) displays, electrophoretic displays and field emission displays. Other features, aspects and advantages will become apparent from the description, the drawings and the claims. Note that the relative dimensions of the following figures may not be drawn to scale.

### BRIEF DESCRIPTION OF THE DRAWINGS

The foregoing discussion will be understood more readily from the following detailed description of the present disclosure with reference to the following drawings:

FIG. 1A shows a schematic diagram of a direct-view microelectromechanical systems (MEMS)-based display apparatus.

FIG. 1B shows a block diagram of a host device.

FIG. 2A shows a perspective view of an illustrative shutter-based light modulator.

FIG. 2B shows a cross sectional view of an illustrative non-shutter-based light modulator.

FIG. 2C shows an example of a field sequential liquid crystal display operating in optically compensated bend (OCB) mode.

FIG. 3 shows a perspective view of an array of shutter-based light modulators.

FIG. 4 shows a timing diagram corresponding to a display process for displaying images using FSC.

FIG. 5 shows a timing sequence employed by the controller for the formation of an image using a series of sub-frame images in a binary time division gray scale process.

FIG. 6 shows a timing diagram that corresponds to a coded-time division gray scale addressing process in which image frames are displayed by displaying four sub-frame images for each color component of the image frame.

FIG. 7 shows a block diagram of a controller for use in a display.

FIG. 8 shows a backplane of a display apparatus including associated drivers.

FIG. 9 shows a graph of three illustrative row addressing timing schemes suitable for use in a display apparatus.

FIGS. 10A-10D show various examples of row addressing timing schemes.

FIG. 11 shows a chart comparing the time allocated for addressing a set of rows according to various row addressing timing schemes.

FIG. 12 shows a portion of an example control matrix.

FIG. 13 shows a flow diagram of one implementation of a method of forming an image on a display.

FIGS. 14A and 14B are system block diagrams illustrating a display device that includes a plurality of display elements.

### DETAILED DESCRIPTION

The amount of time required to address a given row of a display has two primary parameters: the amount of time it takes for a write-enabling signal to propagate to the end of a given row (t_{we}), and the amount of time it takes for a data signal to propagate to the row being addressed (t_{d-prop}). t_{d-prop} increases as the row being addressed is further away from the drivers supplying the data voltage. In some displays, t_{d-prop} begins to exceed t_{we} after some number of rows have been addressed. Thus, to ensure that even the furthest row of pixels is properly addressed, traditional displays provide the amount of time necessary for data to reach this furthest row (t_{d-max}) to address each and every row.

However, providing t_{d-max} for addressing each and every row of a display wastes a great deal of time that could otherwise be used for addressing additional subframes or extending the duration of existing subframes. Thus, in various implementations, controllers integrated into the display apparatus disclosed herein vary the amount of time provided for addressing each row of pixels based on t_{we} and the value of t_{d-prop} for the given row. Accordingly, in some implementations, the controller is configured to provide a first amount of time to address at least one row and a second, greater amount of time to address at least a second row. In some implementations, for all rows in which t_{we} exceeds t_{d-prop}, the controller provides an amount of time of about t_{we} to allow for loading data into such rows. For all rows in which t_{d-prop} exceeds t_{we}, the controller provides a time tₐ at least as long as t_{d-prop} to address the rows. For example, in some implementations, the controller provides a time substantially ally equal to t_{d-prop} for each such row. In some other implementations, rows for which t_{d-prop} exceeds t_{we} are grouped together and are allocated a time tₐ about equal to the amount of time it takes for a data signal to reach the most distant row in the group. In some other implementations, all rows for which their respective t_{d-prop} values exceed t_{we} are allocated a time tₐ substantially equal to t_{d-max}, i.e., the amount of time it takes for a data signal to propagate to the most distant tow in the display.

In some implementations, the display apparatus is a direct-view display apparatus having liquid crystal or electromechanical systems (EMS) light modulators formed on a transparent substrate. In some other implementations, the display apparatus is an emissive display including OLED light emitters.

Particular implementations of the subject matter described in this disclosure can be implemented to realize one or more of the following potential advantages. Speeding up the addressing process as set forth herein can in some cases reduce the amount of time used by a display to address an array of pixels by as much as 50% or more of time it would use if it allocated each row the same amount of time. This saved time allows for the display of additional or longer-duration subframes. Additional subframes can be used to increase the number of colors the display can generate, or can be used to provide redundant subframes to limit image artifacts, such as dynamic false contouring. If the additional time is instead used for generating longer subframes, the display apparatus can operate more efficiently by illuminating its light sources at lower brightness levels.

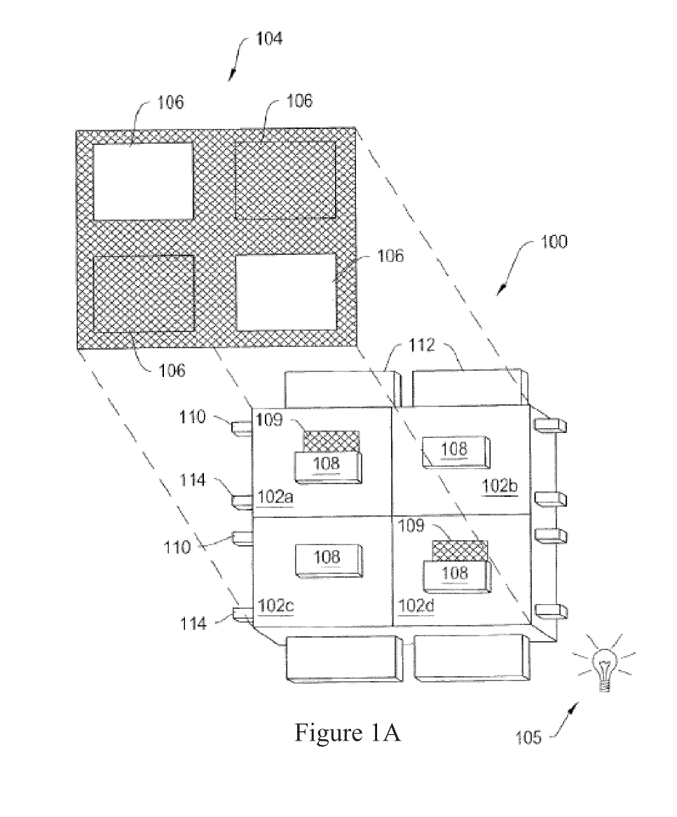

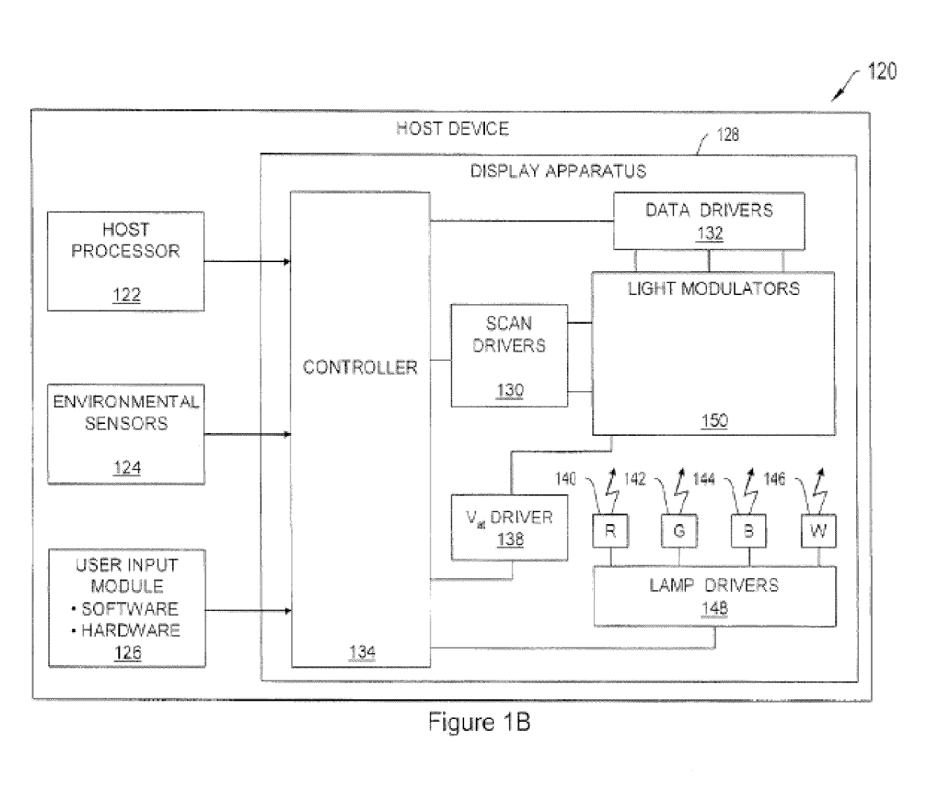

FIG. 1A shows a schematic diagram of a direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (e.g., interconnects 110, 112 and 114), including at least one write-enable interconnect 110 (also referred to as a “scan-line interconnect”) per row of pixels, one data interconnect 112 for each column of pixels and one common interconnect 114 providing a common voltage to all pixels, or at least to pixels from both multiple columns and multiples rows in the display apparatus 100. In response to the application of an appropriate voltage (the “write-enabling voltage, VWE”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, e.g., transistors, thin-film transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows an example of a block diagram 120 of a host device (i.e., cell phone, smart phone, PDA, MP3 player, tablet, e-reader, etc.). The host device includes a display apparatus 128, a host processor 122, environmental sensors 124, a user input module 126 and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146 and lamp drivers 148. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the light modulators, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3, or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in predetermined sequences grouped by rows and by image frames. The data drivers 132 can include series to parallel data converters, level shifting and for some applications digital to analog voltage converters.

The display apparatus optionally includes a set of common drivers 138, also referred to as common voltage sources. In some implementations, the common drivers 138 provide a DC common potential to all light modulators within the array of light modulators, for instance by supplying voltage to a series of common interconnects 114. In some other implementations, the common drivers 138, following commands from the controller 134, issue voltage pulses or signals to the array of light modulators, for instance global actuation pulses which are capable of driving and/or initiating simultaneous actuation of all light modulators in multiple rows and columns of the array. In some implementations, the common drivers 138 output voltages or signals to light modulators in multiple rows and multiple columns of the display apparatus 128, but not to all light modulators in the array.

All of the drivers (e.g., scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array of pixels, the output of voltages from the data drivers 132 and the output of voltages that provide for light modulator actuation.

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz. In some implementations the setting of an image frame to the array is synchronized with the illumination of the lamps 140, 142, 144 and 146 such that alternate image frames are illuminated with an alternating series of colors, such as red, green and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations the data for an image state 104 is loaded by the controller 134 to the modulator array by a sequential addressing of individual rows, also referred to as scan lines. For each row or scan line in the sequence, the scan driver 130 applies a write-enable voltage to the write enable interconnect 110 for that row of the array, and subsequently the data driver 132 supplies data voltages, corresponding to desired shutter states, for each column in the selected row. This process repeats until data has been loaded for all rows in the array. In some implementations, the sequence of selected rows for data loading is linear, proceeding from top to bottom in the array. In some other implementations, the sequence of selected rows is pseudo-randomized, in order to minimize visual artifacts. And in other implementations the sequencing is organized by blocks, where, for a block, the data for only a certain fraction of the image state 104 is loaded to the array, for instance by addressing only every 5th row of the array in sequence.

In some implementations, the process for loading image data to the array is separated in time from the process of actuating the shutters 108. In these implementations, the modulator array may include data memory elements for each pixel in the array and the control matrix may include a global actuation interconnect for carrying trigger signals, from common driver 138, to initiate simultaneous actuation of shutters 108 according to data stored in the memory elements.

In alternative implementations, the array of pixels and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

The host processor 122 generally controls the operations of the host. For example, the host processor may be a general or special purpose processor for controlling a portable electronic device. With respect to the display apparatus 128, included within the host device 120, the host processor outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device. The environmental sensor module receives data about the ambient environment, such as temperature and or ambient lighting conditions. The sensor module 124 can be programmed to distinguish whether the device is operating in an indoor or office environment versus an outdoor environment in bright daylight versus and outdoor environment at nighttime. The sensor module communicates this information to the display controller 134, so that the controller can optimize the viewing conditions in response to the ambient environment.

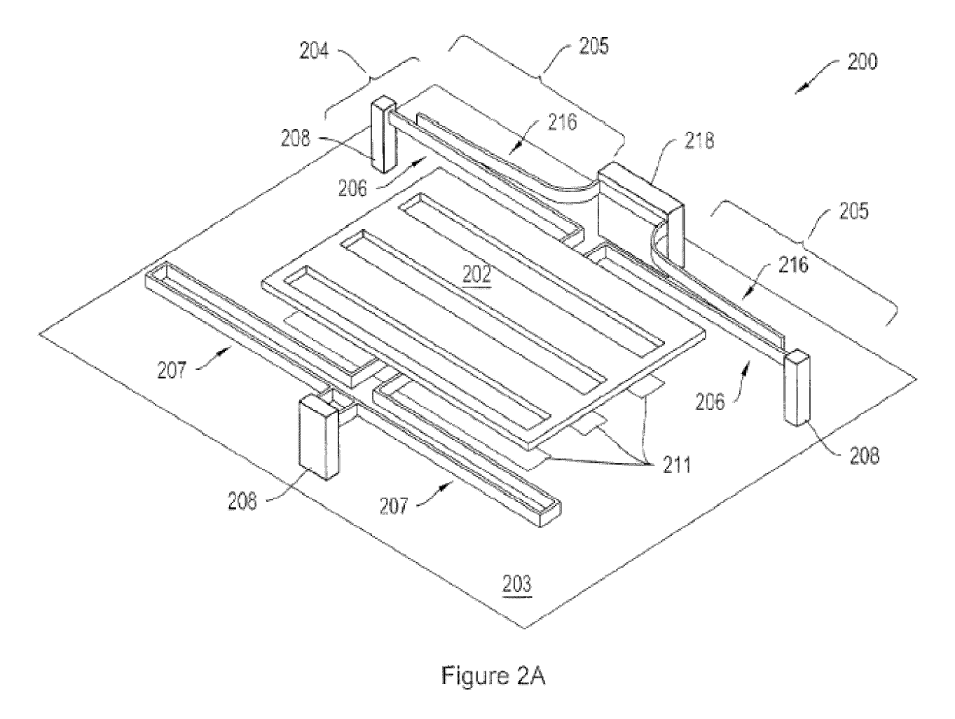

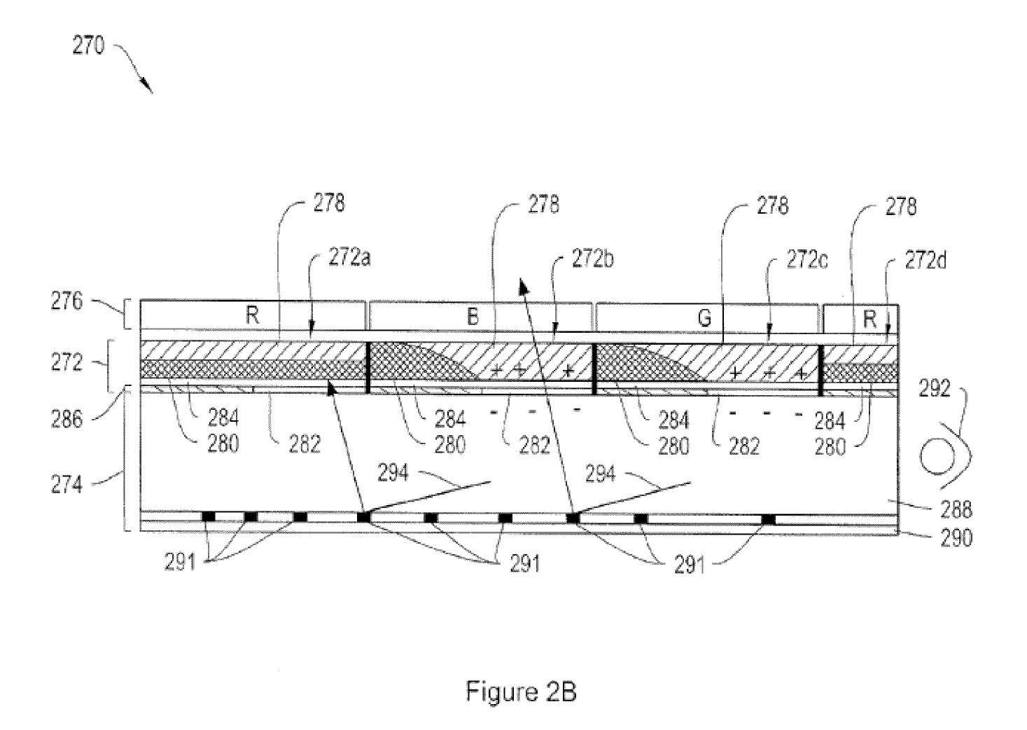

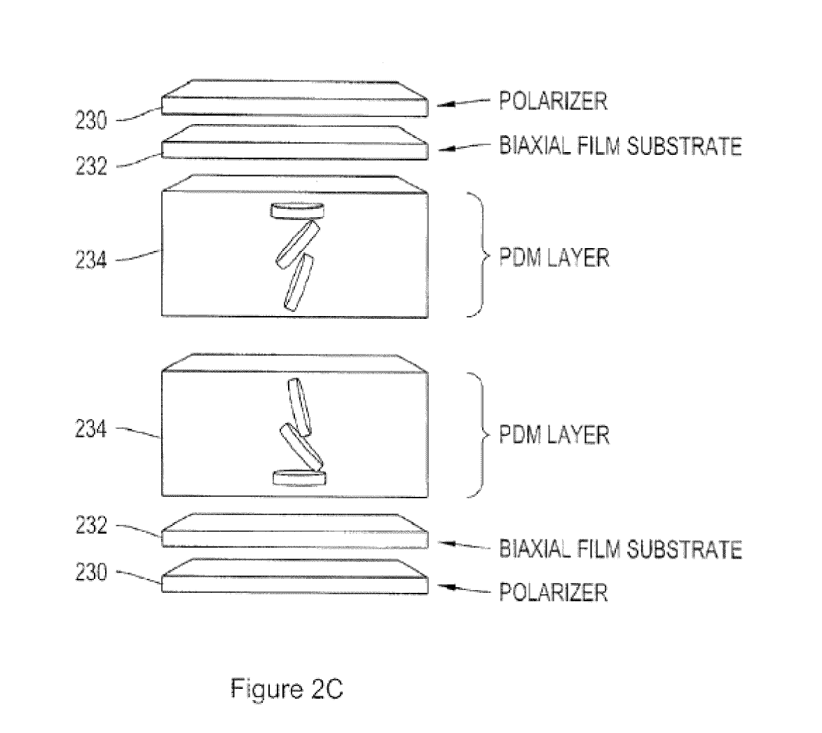

FIG. 2A shows a perspective view of an illustrative shutter-based light modulator 200 suitable for incorporation into the direct-view MEMS-based display apparatus 100 of FIG. 1A. The light modulator 200 includes a shutter 202 coupled to an actuator 204. The actuator 204 can be formed from two separate compliant electrode beam actuators 205 (the “actuators” 205. The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The surface includes one or more aperture holes 211 for admitting the passage of light. The load anchors 208 physically connect the compliant load beams 206 and the shutter 202 to the surface 203 and electrically connect the load beams 206 to a bias voltage, in some instances, ground.

If the substrate is opaque, such as silicon, then aperture holes 211 are formed in the substrate by etching an array of holes through the substrate 204. If the substrate 204 is transparent, such as glass or plastic, then the first block of the processing sequence involves depositing a light blocking layer onto the substrate and etching the light blocking layer into an array of holes 211. The aperture holes 211 can be generally circular, elliptical, polygonal, serpentine, or irregular in shape.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely towards the drive anchor 218. The compliant members 206 act as springs, such that when the voltage across the beams 206 and 216 potential is removed, the load beams 206 push the shutter 202 back into its initial position, releasing the stress stored in the load beams 206.

A light modulator, such as light modulator 200, incorporates a passive restoring force, such as a spring, for returning a shutter to its rest position after voltages have been removed. Other shutter assemblies can incorporate a dual set of “open” and “closed” actuators and a separate sets of “open” and “closed” electrodes for moving the shutter into either an open or a closed state.

There are a variety of methods by which an array of shutters and apertures can be controlled via a control matrix to produce images, in many cases moving images, with appropriate luminance level. In some cases control is accomplished by means of a passive matrix array of row and column interconnects connected to driver circuits on the periphery of the display. In other cases it is appropriate to include switching and/or data storage elements within each pixel of the array (the so-called active matrix) to improve the speed, the luminance level and/or the power dissipation performance of the display.

The controller functions described herein are not limited to controlling shutter-based MEMS light modulators, such as the light modulators described above. FIG. 2B is a cross sectional view of an illustrative non-shutter-based light modulator suitable for inclusion in various implementations of the present disclosure. Specifically, FIG. 2B is a cross sectional view of an electrowetting-based light modulation array 270. The light modulation array 270 includes a plurality of electrowetting-based light modulation cells 272a-d (generally “cells 272”) formed on an optical cavity 274. The light modulation array 270 also includes a set of color filters 276 corresponding to the cells 272.

Each cell 272 includes a layer of water (or other transparent conductive or polar fluid) 278, a layer of light absorbing oil 280, a transparent electrode 282 (made, for example, from indium-tin oxide) and an insulating layer 284 positioned between the layer of light absorbing oil 280 and the transparent electrode 282. In the implementation described herein, the electrode takes up a portion of a rear surface of a cell 272.

The remainder of the rear surface of a cell 272 is formed from a reflective aperture layer 286 that forms the front surface of the optical cavity 274. The reflective aperture layer 286 is formed from a reflective material, such as a reflective metal or a stack of thin films forming a dielectric mirror. For each cell 272, an aperture is formed in the reflective aperture layer 286 to allow light to pass through. The electrode 282 for the cell is deposited in the aperture and over the material forming the reflective aperture layer 286, separated by another dielectric layer.

The remainder of the optical cavity 274 includes a light guide 288 positioned proximate the reflective aperture layer 286, and a second reflective layer 290 on a side of the light guide 288 opposite the reflective aperture layer 286. A series of light redirectors 291 are formed on the rear surface of the light guide, proximate the second reflective layer. The light redirectors 291 may be either diffuse or specular reflectors. One or more light sources 292 inject light 294 into the light guide 288.

In an alternative implementation, an additional transparent substrate is positioned between the light guide 290 and the light modulation array 270. In this implementation, the reflective aperture layer 286 is formed on the additional transparent substrate instead of on the surface of the light guide 290.

In operation, application of a voltage to the electrode 282 of a cell (for example, cell 272b or 272c) causes the light absorbing oil 280 in the cell to collect in one portion of the cell 272. As a result, the light absorbing oil 280 no longer obstructs the passage of light through the aperture formed in the reflective aperture layer 286 (see, for example, cells 272b and 272c). Light escaping the backlight at the aperture is then able to escape through the cell and through a corresponding color filter (for example, red, green, or blue) in the set of color filters 276 to form a color pixel in an image. When the electrode 282 is grounded, the light absorbing oil 280 covers the aperture in the reflective aperture layer 286, absorbing any light 294 attempting to pass through it.

The area under which oil 280 collects when a voltage is applied to the cell 272 constitutes wasted space in relation to forming an image. This area cannot pass light through, whether a voltage is applied or not, and therefore, without the inclusion of the reflective portions of reflective apertures layer 286, would absorb light that otherwise could be used to contribute to the formation of an image. However, with the inclusion of the reflective aperture layer 286, this light, which otherwise would have been absorbed, is reflected back into the light guide 290 for future escape through a different aperture. The electrowetting-based light modulation array 270 is not the only example of a non-shutter-based MEMS modulator suitable for control by the control matrices described herein. Other forms of non-shutter-based MEMS modulators could likewise be controlled by various ones of the controller functions described herein without departing from the scope of this disclosure.

In addition to MEMS displays, this disclosure also may make use of field sequential liquid crystal displays, including for example, liquid crystal displays operating in optically compensated bend (OCB) mode as shown in FIG. 2C. Coupling an OCB mode LCD display with the FSC method may allow for low power and high resolution displays. The LCD of FIG. 2C is composed of a circular polarizer 230, a biaxial retardation film 232 and a polymerized discotic material (PDM) 234. The biaxial retardation film 232 contains transparent surface electrodes with biaxial transmission properties. These surface electrodes act to align the liquid crystal molecules of the PDM layer in a particular direction when a voltage is applied across them.

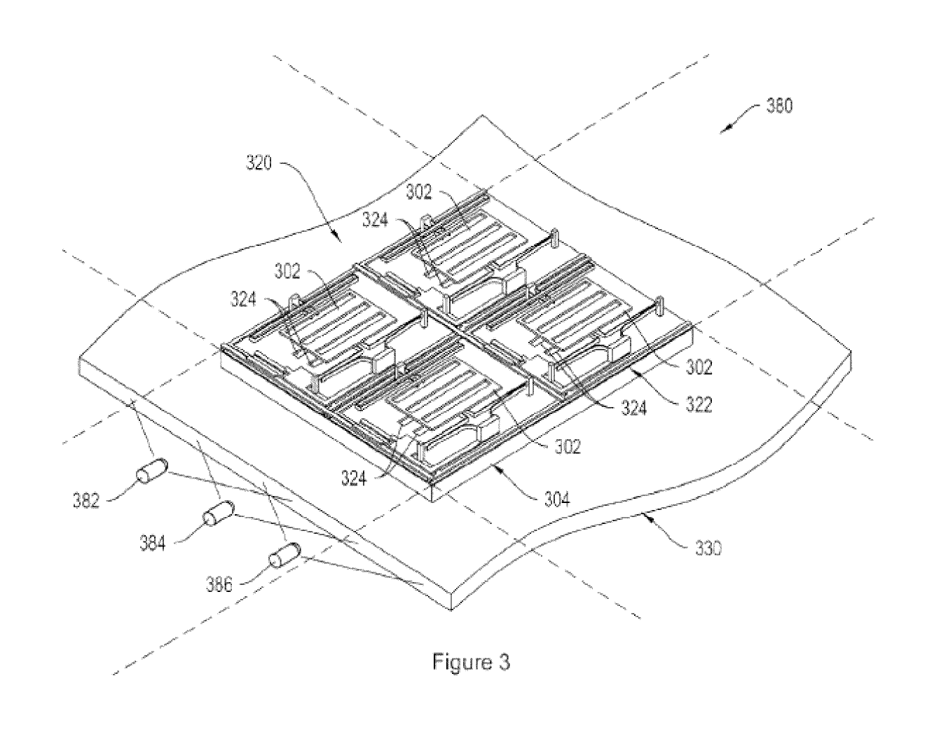

FIG. 3 shows a perspective view of an array 320 of shutter-based light modulators. FIG. 3 also illustrates the array of light modulators 320 disposed on top of backlight 330. In one implementation, the backlight 330 is made of a transparent material, i.e., glass or plastic, and functions as a light guide for evenly distributing light from lamps 382, 384 and 386 throughout the display plane. When assembling the display 380 as a field sequential display, the lamps 382, 384 and 386 can be alternate color lamps, e.g., red, green and blue lamps respectively.

A number of different types of lamps 382-386 can be employed in the displays, including without limitation: incandescent lamps, fluorescent lamps, lasers, or light emitting diodes (LEDs). Further, lamps 382-386 of the direct view display 380 can be combined into a single assembly containing multiple lamps. For instance a combination of red, green and blue LEDs can be combined with or substituted for a white LED in a small semiconductor chip, or assembled into a small multi-lamp package. Similarly each lamp can represent an assembly of 4-color LEDs, for instance a combination of red, yellow, green and blue LEDs or a combination of red, green, blue and white LEDs.

The shutter assemblies 302 function as light modulators. By use of electrical signals from the associated controller, the shutter assemblies 302 can be set into either an open or a closed state. The open shutters allow light from the lightguide 330 to pass through to the viewer, thereby forming a direct view image.

In some implementations, the light modulators are formed on the surface of substrate 304 that faces away from the light guide 330 and toward the viewer. In some other implementations, the substrate 304 can be reversed, such that the light modulators are formed on a surface that faces toward the light guide. In these implementations it is sometimes preferable to form an aperture layer, such as aperture layer 322, directly onto the top surface of the light guide 330. In some other implementations, it is useful to interpose a separate piece of glass or plastic between the light guide and the light modulators, such separate piece of glass or plastic containing an aperture layer, such as aperture layer 322, and associated aperture holes, such as aperture holes 324. It is preferable that the spacing between the plane of the shutter assemblies 302 and the aperture layer 322 be kept as close as possible, preferably less than 10 microns, in some cases as close as 1 micron.

In some displays, color pixels are generated by illuminating groups of light modulators corresponding to different colors, for example, red, green and blue. Each light modulator in the group has a corresponding filter to achieve the desired color. The filters, however, absorb a great deal of light, in some cases as much as 60% of the light passing through the filters, thereby limiting the efficiency and brightness of the display. In addition, the use of multiple light modulators per pixel decreases the amount of space on the display that can be used to contribute to a displayed image, further limiting the brightness and efficiency of such a display.

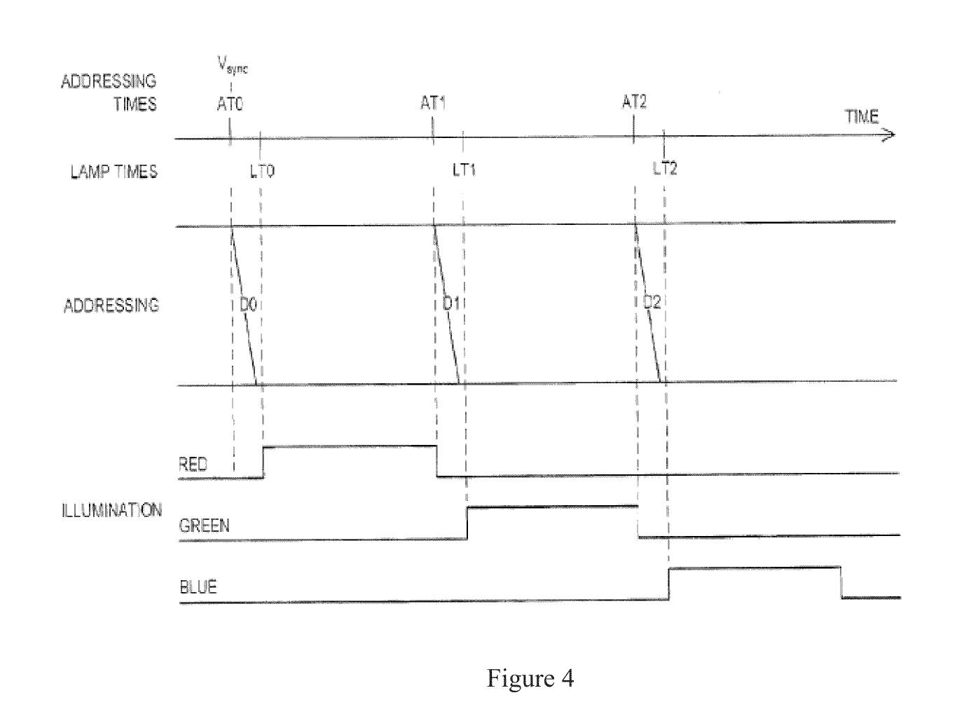

FIG. 4 is a timing diagram 400 corresponding to a display process for displaying images using field sequential color (FSC), which can be implemented, for example, by a MEMS direct-view display described in FIG. 1B. The timing diagrams included herein, including the timing diagram 400 of FIGS. 4, 5, 6 and 7 conform to the following conventions. The top portions of the timing diagrams illustrate light modulator addressing events. The bottom portions illustrate lamp illumination events.

The addressing portions depict addressing events by diagonal lines spaced apart in time. Each diagonal line corresponds to a series of individual data loading events during which data is loaded into each row of an array of light modulators, one row at a time. Depending on the control matrix used to address and drive the modulators included in the display, each loading event may require a waiting period to allow the light modulators in a given row to actuate. In some implementations, all rows in the array of light modulators are addressed prior to actuation of any of the light modulators. Upon completion of loading data into the last row of the array of light modulators, all light modulators are actuated substantially simultaneously.

Lamp illumination events are illustrated by pulse trains corresponding to each color of lamp included in the display. Each pulse indicates that the lamp of the corresponding color is illuminated, thereby displaying the subframe image loaded into the array of light modulators in the immediately preceding addressing event.

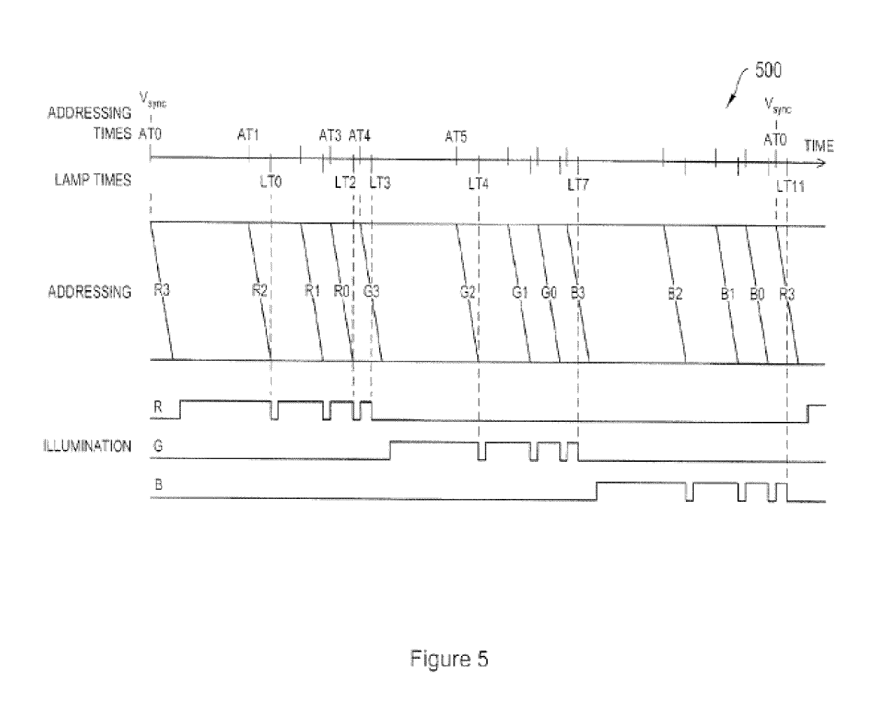

The time at which the first addressing event in the display of a given image frame begins is labeled on each timing diagram as AT0. In most of the timing diagrams, this time falls shortly after the detection of a voltage pulse vsync, which precedes the beginning of each video frame received by a display. The times at which each subsequent addressing event takes place are labeled as AT1, AT2, . . . AT(n−1), where n is the number of subframe images used to display the image frame. In some of the timing diagrams, the diagonal lines are further labeled to indicate the data being loaded into the array of light modulators. For example, in the timing diagram of FIG. 4, D0 represents the first data loaded into the array of light modulators for a frame and D(n−1) represents the last data loaded into the array of light modulators for the frame. In the timing diagrams of FIGS. 5-7, the data loaded during each addressing event corresponds to a bitplane.

A bitplane is a coherent set of data identifying desired modulator states for modulators in multiple rows and multiple columns of an array of light modulators. Moreover, each bitplane corresponds to one of a series of subframe images derived according to a binary coding scheme. That is, each subframe image for a contributing color of an image frame is weighted according to a binary series 1, 2, 4, 8, 16, etc. The bitplane with the lowest weighting is referred to as the least significant bitplane and is labeled in the timing diagrams and referred to herein by the first letter of the corresponding contributing color followed by the number 0. For each next-most significant bitplane for the contributing colors, the number following the first letter of the contributing color increases by one. For example, for an image frame broken into 4 bitplanes per color, the least significant red bitplane is labeled and referred to as the R0 bitplane. The next most significant red bitplane is labeled and referred to as R1, and the most significant red bitplane is labeled and referred to as R3.

Lamp-related events are labeled as LT0, LT1, LT2 . . . LT(n−1). The lamp-related event times labeled in a timing diagram, depending on the timing diagram, either represent times at which a lamp is illuminated or times at which a lamp is extinguished. The meaning of the lamp times in a particular timing diagram can be determined by comparing their position in time relative to the pulse trains in the illumination portion of the particular timing diagram. Specifically referring back to the timing diagram 400 of FIG. 4, to display an image frame according to the timing diagram 400, a single subframe image is used to display each of three contributing colors of an image frame. First, data, D0, indicating modulator states desired for a red subframe image are loaded into an array of light modulators beginning at time AT0. After addressing is complete, the red lamp is illuminated at time LT0, thereby displaying the red subframe image. Data, D1, indicating modulator states corresponding to a green subframe image are loaded into the array of light modulators at time AT1. A green lamp is illuminated at time LT1. Finally, data, D2, indicating modulator states corresponding to a blue subframe image are loaded into the array of light modulators and a blue lamp is illuminated at times AT2 and LT2, respectively. The process then repeats for subsequent image frames to be displayed.

The number of luminance levels achievable by a display that forms images according to the timing diagram of FIG. 4 depends on how finely the state of each light modulator can be controlled. For example, if the light modulators are binary in nature, i.e., they can only be on or off, the display will be limited to generating 8 different colors. The number of luminance levels can be increased for such a display by providing light modulators than can be driven into additional intermediate states. In some implementations related to the field sequential technique of FIG. 4, MEMS-based or other light modulators can be provided which exhibit an analog response to applied voltage. The number of luminance levels achievable in such a display is limited only by the resolution of digital to analog converters which are supplied in conjunction with data voltage sources.

Alternatively, finer luminance level can be generated if the time period used to display each subframe image is split into multiple time periods, each having its own corresponding subframe image. For example, with binary light modulators, a display that forms two subframe images of equal length and light intensity per contributing color can generate 27 different colors instead of 8. Luminance level techniques that break each contributing color of an image frame into multiple subframe images are referred to, generally, as time division gray scale techniques.

FIG. 5 illustrates an example of a timing sequence, referred to as a display process 500, employed by controller 134 for the formation of an image using a series of subframe images in a binary time division gray scale. The controller 134, used with the display process 500, is responsible for coordinating multiple operations in the timed sequence (time varies from left to right in FIG. 5). The controller 134 determines when data elements of a subframe data set are transferred out of the frame buffer and into the data drivers 132. The controller 134 also sends trigger signals to enable the scanning of rows in the array by means of scan drivers 130, thereby enabling the loading of data from the data from drivers 132 into the pixels of the array. The controller 134 also governs the operation of the lamp drivers 148 to enable the illumination of the lamps 140, 142 and 144 (the white lamp 146 is not employed in the display process 500). The controller 134 also sends trigger signals to the common drivers 138 which enable functions such as the global actuation of shutters substantially simultaneously in multiple rows and columns of the array.

The process of forming an image in the display process 500 includes, for each subframe image, first the loading of a subframe data set out of the frame buffer and into the array. A subframe data set includes information about the desired states of modulators (e.g., open or closed) in multiple rows and multiple columns of the array. For binary time division gray scale, a separate subframe data set is transmitted to the array for each bit level within each color in the binary coded word for gray scale. For the case of binary coding, a subframe data set is referred to as a bit plane. The display process 500 refers to the loading of 4 bitplane data sets in each of the three colors red, green and blue. These data sets are labeled as R0-R3 for red, G0-G3 for green and B0-B3 for blue. For economy of illustration, only 4 bit levels per color are illustrated in the display process 500, although it will be understood that alternate image forming sequences are possible that employ 6, 7, 8, or 10 bit levels per color.

The display process 500 refers to a series of addressing times AT0, AT1, AT2, etc. These times represent the beginning times or trigger times for the loading of particular bitplanes into the array. The first addressing time AT0 coincides with Vsync, which is a trigger signal commonly employed to denote the beginning of an image frame. The display process 500 also refers to a series of lamp illumination times LT0, LT1, LT2, etc., which are coordinated with the loading of the bitplanes. These lamp triggers indicate the times at which the illumination from one of the lamps 140, 142 and 144 is extinguished. The illumination pulse periods and amplitudes for each of the red, green and blue lamps are illustrated along the bottom of FIG. 5, and labeled along separate lines by the letters “R”, “G” and “B”.

The loading of the first bitplane R3 commences at the trigger point AT0. The second bitplane to be loaded, R2, commences at the trigger point AT1. The loading of each bitplane requires a substantial amount of time. For instance the addressing sequence for bitplane R2 commences in this illustration at AT1 and ends at the point LT0. The addressing or data loading operation for each bitplane is illustrated as a diagonal line in timing diagram 500. The diagonal line represents a sequential operation in which individual rows of bitplane information are transferred out of the frame buffer, one at a time, into the data drivers 132 and from there into the array. The loading of data into each row or scan line requires anywhere from 1 microsecond to 100 microseconds. The complete transfer of multiple rows or the transfer of a complete bitplane of data into the array can take anywhere from 100 microseconds to 5 milliseconds, depending on the number of rows in the array.

In the display process 500, the process for loading image data to the array is separated in time from the process of moving or actuating the shutters 108. For this implementation, the modulator array includes data memory elements, such as a storage capacitor, for each pixel in the array and the process of data loading involves only the storing of data (i.e., on-off or open-close instructions) in the memory elements. The shutters 108 do not move until a global actuation signal is generated by one of the common drivers 138. The global actuation signal is not sent by the controller 134 until all of the data has been loaded to the array. At the designated time, all of the shutters designated for motion or change of state are caused to move substantially simultaneously by the global actuation signal. A small gap in time is indicated between the end of a bitplane loading sequence and the illumination of a corresponding lamp. This is the time required for global actuation of the shutters. The global actuation time is illustrated, for example, between the trigger points LT2 and AT4. It is preferable that all lamps be extinguished during the global actuation period so as not to confuse the image with illumination of shutters that are only partially closed or open. The amount of time required for global actuation of shutters, such as in shutter assemblies 320, can take, depending on the design and construction of the shutters in the array, anywhere from 10 microseconds to 500 microseconds.

For the example of the display process 500 the sequence controller is programmed to illuminate just one of the lamps after the loading of each bitplane, where such illumination is delayed after loading data of the last scan line in the array by an amount of time equal to the global actuation time. Note that loading of data corresponding to a subsequent bitplane can begin and proceed while the lamp remains on, since the loading of data into the memory elements of the array does not immediately affect the position of the shutters.

Each of the subframe images, e.g., those associated with bitplanes R3, R2, R1 and R0 is illuminated by a distinct illumination pulse from the red lamp 140, indicated in the “R” line at the bottom of FIG. 5. Similarly, each of the subframe images associated with bitplanes G3, G2, G1 and G0 is illuminated by a distinct illumination pulse from the green lamp 142, indicated by the “G” line at the bottom of FIG. 5. The illumination values (for this example the length of the illumination periods) used for each subframe image are related in magnitude by the binary series 8, 4, 2, 1, respectively. This binary weighting of the illumination values enables the expression or display of a gray scale value coded in binary words, where each bitplane contains the pixel on-off data corresponding to just one of the place values in the binary word. The commands that emanate from the sequence controller 160 ensure not only the coordination of the lamps with the loading of data but also the correct relative illumination period associated with each data bitplane.

A complete image frame is produced in the display process 500 between the two subsequent trigger signals Vsync. A complete image frame in the display process 500 includes the illumination of 4 bitplanes per color. For a 60 Hz frame rate the time between Vsync signals is 16.6 milliseconds. The time allocated for illumination of the most significant bitplanes (R3, G3 and B3) can be in this example approximately 2.4 milliseconds each. By proportion then, the illumination times for the next bitplanes R2, G2 and B2 would be 1.2 milliseconds. The least significant bitplane illumination periods, R0, G0 and B0, would be 300 microseconds each. If greater bit resolution were to be provided, or more bitplanes desired per color, the illumination periods corresponding to the least significant bitplanes would require even shorter periods, substantially less than 100 microseconds each.

It may be useful, in the development or programming of the sequence controller 160, to co-locate or store all of the critical sequencing parameters governing expression of luminance level in a sequence table, sometimes referred to as the sequence table store. An example of a table representing the stored critical sequence parameters is listed below as Table 1. The sequence table lists, for each of the subframes or “fields” a relative addressing time (e.g., AT0, at which the loading of a bitplane begins), the memory location of associated bitplanes to be found in buffer memory 159 (e.g., location M0, M1, etc.), an identification codes for one of the lamps (e.g., R, G, or B), and a lamp time (e.g., LT0, which in this example determines that time at which the lamp is turned off).

TABLE 1
Sequence Table 1

| | Field | Field | Field | Field | Field | Field | Field | | Field | Field |
|---|---|---|---|---|---|---|---|---|---|---|
| | 1 | 2 | 3 | 4 | 5 | 6 | 7 | . . . | n − 1 | n |
| addressing time | AT0 | AT1 | AT2 | AT3 | AT4 | AT5 | AT6 | . . . | AT(n − 1) | ATn |
| memory location | M0 | M1 | M2 | M3 | M4 | M4 | M6 | . . . | M(n − 1 ) | Mn |
| of subframe | | | | | | | | | | |
| data set | | | | | | | | | | |
| lamp ID | R | R | R | R | G | G | G | . . . | B | B |
| lamp time | LT0 | LT1 | LT2 | LT3 | LT4 | LT5 | LT6 | . . . | LT(n − 1) | LTn |

Also, it may be useful to co-locate the storage of parameters in the sequence table to facilitate an easy method for re-programming or altering the timing or sequence of events in a display process. For instance, it is possible to re-arrange the order of the color subframes so that most of the red subframes are immediately followed by a green subframe, and the green are immediately followed by a blue subframe. Such rearrangement or interspersing of the color subframes increase the nominal frequency at which the illumination is switched between lamp colors, which reduces the impact of CBU. By switching between a number of different schedule tables stored in memory, or by re-programming of schedule tables, it is also possible to switch between processes requiring either a lesser or greater number of bitplanes per color—for instance by allowing the illumination of 8 bitplanes per color within the time of a single image frame. It is also possible to easily re-program the timing sequence to allow the inclusion of subframes corresponding to a fourth color LED, such as the white lamp 146.

The display process 500 establishes gray scale or luminance level according to a coded word by associating each subframe image with a distinct illumination value based on the pulse width or illumination period in the lamps. Alternate methods are available for expressing illumination value. In one alternative, the illumination periods allocated for each of the subframe images are held constant and the amplitude or intensity of the illumination from the lamps is varied between subframe images according to the binary ratios 1, 2, 4, 8, etc. For this implementation, the format of the sequence table is changed to assign unique lamp intensities for each of the subframes instead of a unique timing signal. In some other implementations, both the variations of pulse duration and pulse amplitude from the lamps are employed and both specified in the sequence table to establish luminance level distinctions between subframe images.

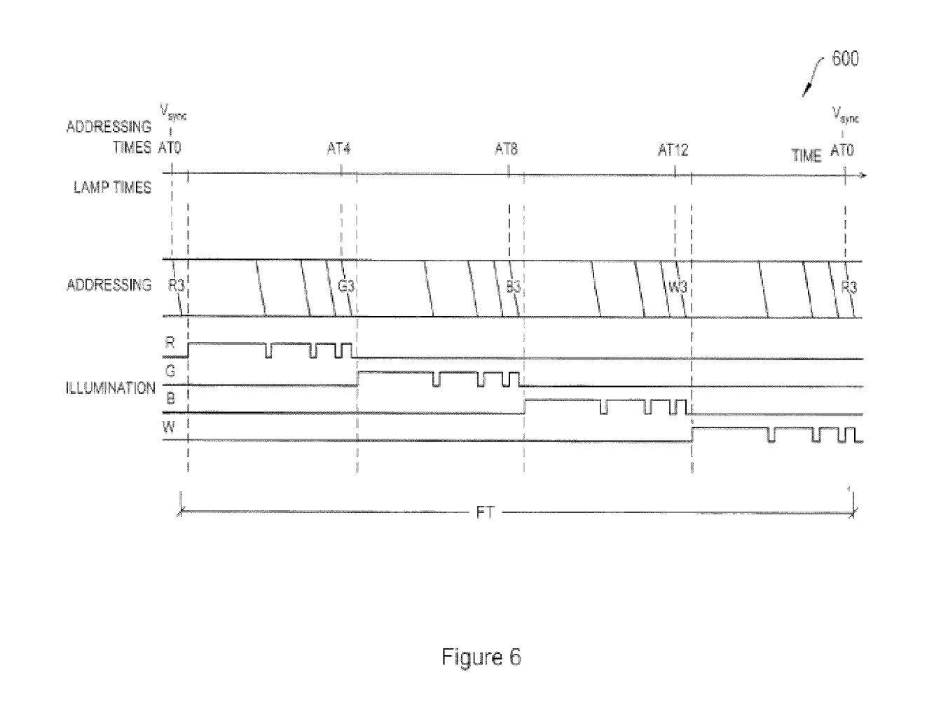

FIG. 6 is a timing diagram 600 that utilizes the parameters listed in Table 2. The timing diagram 600 corresponds to a coded-time division gray scale addressing process in which image frames are displayed by displaying four subframe images for each contributing color of the image frame. Each subframe image displayed of a given color is displayed at the same intensity for half as long a time period as the prior subframe image, thereby implementing a binary weighting scheme for the subframe images. The timing diagram 600 includes subframe images corresponding to the color white, in addition to the colors red, green and blue, which are illuminated using a white lamp. The addition of a white lamp allows the display to display brighter images or operates its lamps at lower power levels while maintaining the same brightness level. As brightness and power consumption are not linearly related, the lower illumination level operating mode, while providing equivalent image brightness, consumes less energy. In addition, white lamps are often more efficient, i.e. they consume less power than lamps of other colors to achieve the same brightness.

More specifically, the display of an image frame in timing diagram 600 begins upon the detection of a vsync pulse. As indicated on the timing diagram and in the Table 2 schedule table, the bitplane R3, stored beginning at memory location M0, is loaded into the array of light modulators 150 in an addressing event that begins at time AT0. Once the controller 134 outputs the last row data of a bitplane to the array of light modulators 150, the controller 134 outputs a global actuation command. After waiting the actuation time, the controller 134 causes the red lamp to be illuminated. Since the actuation time is a constant for all subframe images, no corresponding time value needs to be stored in the schedule table store to determine this time. At time AT4, the controller 134 begins loading the first of the green bitplanes, G3, which, according to the schedule table, is stored beginning at memory location M4. At time AT8, the controller 134 begins loading the first of the blue bitplanes, B3, which, according to the schedule table, is stored beginning at memory location M8. At time AT12, the controller 134 begins loading the first of the white bitplanes, W3, which, according to the schedule table, is stored beginning at memory location M12. After completing the addressing corresponding to the first of the white bitplanes, W3, and after waiting the actuation time, the controller causes the white lamp to be illuminated for the first time.

Because all the bitplanes are to be illuminated for a period longer than the time it takes to load a bitplane into the array of light modulators 150, the controller 134 extinguishes the lamp illuminating a subframe image upon completion of an addressing event corresponding to the subsequent subframe image. For example, LT0 is set to occur at a time after AT0 which coincides with the completion of the loading of bitplane R2. LT1 is set to occur at a time after AT1 which coincides with the completion of the loading of bitplane R1.

The time period between vsync pulses in the timing diagram is indicated by the symbol FT, indicating a frame time. In some implementations, the addressing times AT0, AT1, etc. as well as the lamp times LT0, LT1, etc. are designed to accomplish 4 subframe images for each of the 4 colors within a frame time FT of 16.6 milliseconds, i.e., according to a frame rate of 60 Hz. In some other implementations, the time values stored in the schedule table store can be altered to accomplish 4 subframe images per color within a frame time FT of 33.3 milliseconds, i.e., according to a frame rate of 30 Hz. In some other implementations, frame rates as low as 24 Hz may be employed or frame rates in excess of 100 Hz may be employed.

TABLE 2
Schedule Table 2

| | Field | Field | Field | Field | Field | Field | Field | | Field | Field |
|---|---|---|---|---|---|---|---|---|---|---|
| | 1 | 2 | 3 | 4 | 5 | 6 | 7 | . . . | n − 1 | n |
| addressing time | AT0 | AT1 | AT2 | AT3 | AT4 | AT5 | AT6 | . . . | AT (n − 1) | ATn |
| memory Location | M0 | M1 | M2 | M3 | M4 | M4 | M6 | . . . | M9(n − 1) | Mn |
| of subframe | | | | | | | | | | |
| data set | | | | | | | | | | |
| Lamp ID | R | R | R | R | G | G | G | . . . | W | W |

The use of white lamps can improve the efficiency of the display. The use of four distinct colors in the subframe images requires changes to the data processing in the input processing module 1003. Instead of deriving bitplanes for each of 3 different colors, a display process according to timing diagram 600 requires bitplanes to be stored corresponding to each of 4 different colors. The input processing module 1003 may therefore convert the incoming pixel data, encoded for colors in a 3-color space, into color coordinates appropriate to a 4-color space before converting the data structure into bitplanes.

In addition to the red, green, blue and white lamp combination, shown in the timing diagram 600, other lamp combinations are possible which expand the space or gamut of achievable colors. A useful 4-color lamp combination with expanded color gamut is red, blue, true green (about 520 nm) plus parrot green (about 550 nm). Another 5-color combination which expands the color gamut is red, green, blue, cyan and yellow. A 5-color analogue to the YIQ NTSC color space can be established with the lamps white, orange, blue, purple and green. A 5-color analog to the well known YUV color space can be established with the lamps white, blue, yellow, red and cyan.

Other lamp combinations are possible. For instance, a useful 6-color space can be established with the lamp colors red, green, blue, cyan, magenta and yellow. A 6-color space also can be established with the colors white, cyan, magenta, yellow, orange and green. A large number of other 4-color and 5-color combinations can be derived from amongst the colors already listed above. Further combinations of 6, 7, 8 or 9 lamps with different colors can be produced from the colors listed above. Additional colors may be employed using lamps with spectra which lie in between the colors listed above.

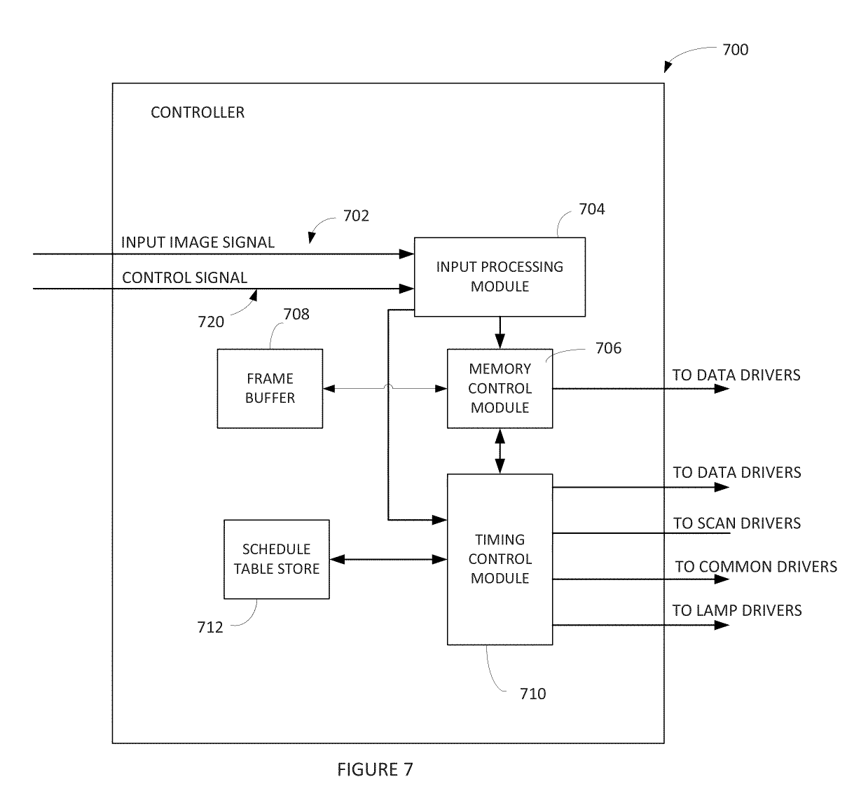

FIG. 7 shows a block diagram of a controller 700 for use in a display. For example, the controller 700 may serve as the controller 134 of FIG. 1B. More particularly, the controller 700 is configured to generate subframe images for display in part by using/and or selecting a variable composite color replacement multiplier, a, to adjust a fraction of the luminance of an image frame output as a composite color, i.e., a color that is substantially a combination of at least two other contributing colors output by the display. The contributing colors that combine to form the composite colors are referred to herein as “component colors.” For example, white is a composite of color having component colors of red, green and blue. Similarly, yellow is composite color having red and green as component colors. The component and composite colors are referred to collectively as “contributing” colors or individually as a “contributing” color.

With reference to FIGS. 7 and 1B, in general, the controller 700 receives an image signal 702 from an image source and generates outputs data and control signals to the drivers 130, 132, 138 and 148 to control the light modulators in the array of light modulators 150 and the lamps 140, 142, 144 and 146 of the display apparatus 128. The order in which the data and control signals are output is referred to herein as an “output sequence,” described further below. While the functionality of the controller 700 is described herein with respect to display apparatus incorporating light modulators, e.g., MEMS shutters, MEMS mirrors, LCD or electro-wetting cells, etc., the functionality also is applicable for emissive displays, such as OLED-based displays.

To carry out the above described functionality, the controller 700 includes an input processing module 704, a memory control module 706, a frame buffer 708, a timing control module 710 and a schedule table store 712. In some implementations, these components may be provided as distinct chips or circuits which are connected together by means of circuit boards, cables, or other electrical interconnects. In other implementations several of these components can be designed together into a single semiconductor chip such that their boundaries are nearly indistinguishable except by function. In other implementations, some of the components can be implemented in firmware or software executing on a microprocessor incorporated into the controller 700.

The input processing module 704 receives the image signal 702 as input and processes the data encoded therein into a format suitable for displaying via the array of light modulators 150. To that end, the input processing module 704 takes the data encoding each image frame and converts it into a series of sub-frame data sets. A sub-frame data set includes information about the desired states of modulators in multiple rows and multiple columns of the array of light modulators 150 aggregated into a coherent data structure. The number and content of sub-frame data sets used to display an image frame depends on the grayscale technique employed by the controller 700. In general, a gray scale technique refers to a process by which the display apparatus varies the luminance level output for a given contributing color of the display. For example, the sub-frame data sets used to form an image frame using a coded time-division gray scale technique differ from the number and content of sub-frame data sets used to display an image frame using a non-coded time division gray scale technique. In various implementations, the input processing module 704 may convert the image signal 705 into non-coded sub-frame data sets, bitplanes, ternary coded sub-frame data sets, or other form of coded sub-frame data set.

The input processing module 704 outputs the sub-frame data sets to the memory control module 706. The memory control module 706 then stores the sub-frame data sets in the frame buffer 708. The frame buffer is 708 preferably a random access memory, although other types of serial memory can be used without departing from the scope of the invention. The memory control module 706, in one implementation, stores the sub-frame data set in a predetermined memory location based on the color and significance in a coding scheme of the sub-frame data set. In other implementations, the memory control module 706 stores the sub-frame data set in a dynamically determined memory location and stores that location in a lookup table for later identification.

The memory control module 706 also is responsible for, upon instruction from the timing control module 710, retrieving sub-frame data sets from the frame buffer 708 and outputting them to the data drivers 132. The data drivers 132 load the data output from the memory control module 706 into the light modulators of the array of light modulators 150. The memory control module 706 outputs the data in the sub-image data sets one row at a time. In one implementation, the frame buffer 708 includes two buffers, whose roles alternate. While the memory control module 706 stores newly generated sub-frame data sets corresponding to a new image frame in one buffer, it extracts sub-frame data sets corresponding to the previously received image frame from the other buffer for output to the array of light modulators 150. Both buffer memories can reside within the same circuit, separated only by address.

The timing control module 710 manages the output by the controller 700 of data and command signals according to an output sequence. The output sequence includes the order and timing with which sub-frame data sets are output to the array of light modulators 150 and the timing and character of illumination events. The output sequence, in some implementations, also includes global actuation events. At least some of the parameters that define the output sequence are stored in volatile memory. This volatile memory is referred to as schedule table store 712. The schedule table store 712 stores one or more schedule tables as described above in relation to FIGS. 5 and 6.

The output sequence parameters stored in the schedule table store 712 vary in different implementations of the display apparatus disclosed herein. In one implementation, the schedule table store 712 stores timing values associated with each sub-frame data set. For example, the schedule table store 712 may store timing values associated with the beginning of each addressing event in the output sequence, as well as timing values associated with lamp illumination and/or lamp extinguishing events. In other implementations, the schedule table store 712 stores lamp intensity values instead of or in addition to timing values associated with addressing events. In various implementations, the schedule table store 712 stores an identifier indicating where each sub-image data set is stored in the frame buffer 708, and illumination data indicating the color or colors associated with each respective sub-image data set.

The nature of the timing values stored in the schedule table store 712 can vary depending on the specific implementation of the controller 700. The timing value, as stored in the schedule table store 712, in one implementation, is a number of clock cycles, which for example, have passed since the initiation of the display of an image frame, or since the last addressing or lamp event was triggered. Alternatively, the timing value may be an actual time value, stored in microseconds or milliseconds.

Address data in the schedule table can be stored in a number of forms. For example, in one implementation, the address is a specific memory location in the frame buffer 708 of the beginning of the corresponding bitplane, referenced by buffer, column and row numbers. In another implementation, the address stored in the schedule table store 712 is an identifier for use in conjunction with a sub-frame data set lookup table maintained by the memory control module 706. For example, the identifier may have a simple 6-bit binary “xxxxxx” word structure where the first 2 bits identify the color associated with the bitplane, while the next 4 bits refer to the significance of the bitplane. The actual memory location of the bitplane is then stored in a lookup table maintained by the memory control module 706 when the memory control module 706 stores the bitplane into the frame buffer. In other implementations the memory locations for bitplanes in the output sequence may be stored as hardwired logic within the timing control module 710.

The timing control module 710 may retrieve schedule table entries using several different methods. In one implementation the order of entries in the schedule table is fixed; the timing control module 710 retrieves each entry in order until reaching a special entry that designates the end of the sequence. Alternatively, a sequence table entry may contain codes that direct the timing control module 710 to retrieve an entry which may be different from the next entry in the table. These additional fields may incorporate the ability to perform jumps, branches and looping in analogy with the control features of a standard microprocessor instruction set. Such flow control modifications to the operation of the timing control module 710 allow a reduction in the size of the sequence table.

The input processing module 704 of the controller 700 also receives control signals 720 from other components of the host device. As described in FIG. 1B, the controller 700 can receive control signals 720 from the host processor 122, environmental sensors and/or various user interface devices. Based on the control signals 720, the input processing module 704 selects an imaging mode for use in outputting received image data. The selection of the imaging mode in turns governs the selection of the sequence tables stored in the schedule table store 712. The control signals 720 can include explicit instructions with respect to imaging mode selection, or it can include data from which the input processing module 704 can process to select an imaging mode. For example, the control signals can include ambient light data, power savings mode data, battery level data, user preference data and/or content metadata. In certain implementations, the input processing module 704 processes the control signals 720 in conjunction with the actual content of the input image signal 702 to select an appropriate imaging mode.

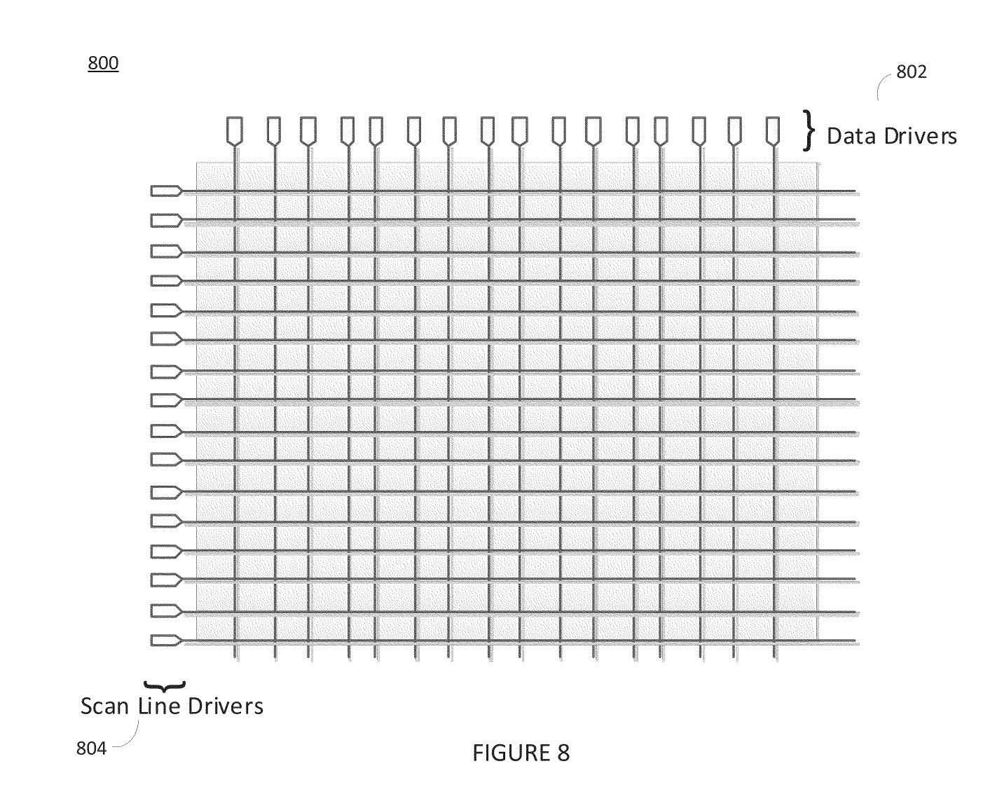

FIG. 8 shows a backplane 800 of a display apparatus including associated drivers. The backplane 800 includes data drivers 802 and scan line drivers 804. The backplane 800 includes an array of pixels arranged in rows and columns. Each column of pixels is addressed by a data line that runs the length of the backplane 800. A data driver 802 is coupled to each data line to output a data voltage down a corresponding data line. Each pixel in a given row is coupled to a common scan line (also referred to as a write enabling interconnect), which is in turn coupled to a scan line driver 804. The scan line drivers 804 sequentially apply write enabling voltages to scan lines, enabling the pixels in the rows coupled to the scan lines to receive and store the data voltages output by the data drivers 802. Additional interconnects not shown may also provide additional signals. For example, a global actuation interconnect may electrically couple to all the pixels in the display, or at least to pixels in multiple rows and multiple columns of the display, to output a signal to all such pixels substantially simultaneously.

In many displays, the length of a row of pixels is often longer than any given column of pixels. However, due to varying parasitic capacitances, different interconnect geometries and different interconnect resistivities, the actual signal propagation rate within the data lines may be significantly slower than the signal propagation rate in a scan line interconnect. Thus, notwithstanding the data lines having a shorter length, in many displays, it still may take longer for a data signal to propagate down a data line than for a write enabling signal to propagate to the end of a scan line.

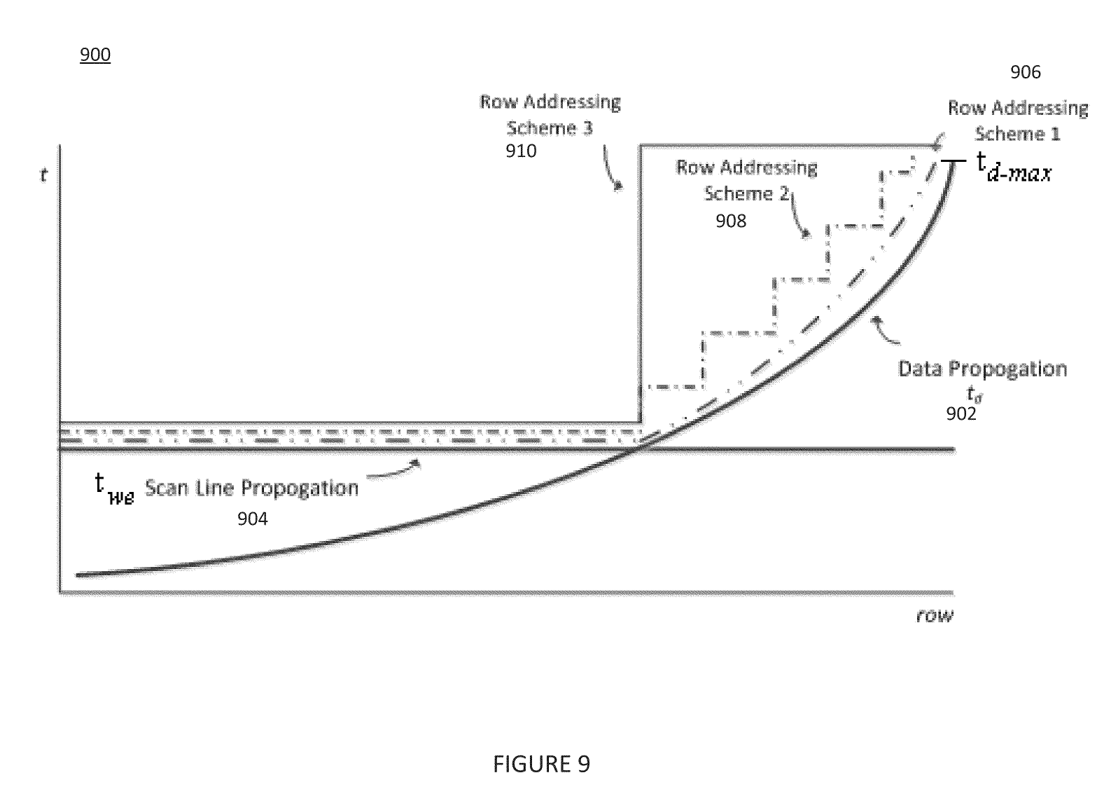

FIG. 9 shows a graph 900 of three illustrative row addressing timing schemes suitable for use in a display apparatus. The x-axis of the graph 900 corresponds to the rows of a display, where the distance of a row from a data driver increases from left to right. The y-axis corresponds to the amount of time it takes for a signal output by a driver to reach that row. For reference, the graph 900 includes a data signal propagation curve 902 that indicates the amount of time, t_{d-prop}, it takes for a data signal to propagate down a data line and a scan line propagation curve 904 that indicates the amount of time, t_{we}, it takes a write enabling signal output by a scan line driver to reach the end of a row. The data signal propagation curve 902 starts at a point that is below the scan line propagation curve 904 and increases approximately quadratically to a maximum data propagation time, t_{d-max}, corresponding to the amount of time it takes for a data signal to reach the last row of the display. In contrast, the scan line propagation curve is substantially flat, as the amount of time it takes a write enabling signal to propagate down a row is substantially constant row-to-row. At some distance away from the data drivers, referred to herein as the intersection distance, the data signal propagation curve 902 intersects the scan line propagation curve 904. For rows at a distance from their respective data drivers greater than the intersection distance, it takes a longer amount of time for a data signal to reach a given row than it does for a write enabling signal to reach the end of that row.

In addition to the data signal propagation curve 902 and the scan line propagation curve 904, the graph 900 includes three curves 906, 908, and 910 corresponding to three respective row addressing timing schemes that can be implemented by controllers of display apparatus in various implementations. A first curve 906 corresponds to a first row addressing timing scheme. A second curve 908 corresponds to a second row addressing timing scheme. A third curve 910 corresponds to a third row addressing timing scheme. In each row addressing timing scheme, all rows within the intersection distance from their respective drivers are allocated the same amount of time, i.e., tₐ=t_{we}, load data into the row. The amount of time allocated to more distant rows, though, varies in each row addressing timing scheme, as is discussed further below.

In the first row addressing timing scheme, corresponding to curve 906 of FIG. 9, the time tₐ allocated for addressing each row beyond the intersection distance is substantially matched, within the timing resolution limitations of the display clocks and driver circuits, to the actual amount of time it takes for a data signal to propagate to that row, i.e., t_{d-prop}. Thus, in some implementations, each row is allocated a different amount of time.

In the second row addressing timing scheme, corresponding to curve 908 of FIG. 9, rows located beyond the intersection distance are allocated time tₐ for addressing in groups. For example, in some implementations, addressing times are allocated in groups of between 10 and 100 rows at a time. As the time t_{d-prop} it takes for a signal to reach a given row increases approximately quadratically, in some implementations, a larger number of rows are assigned to groups of rows located closer to the intersection distance, where the slope of the data signal propagation curve 902 is lower, and a smaller number of rows are assigned to groups of rows as the distance from the intersection distance, and the slope of the data signal propagation curve 902, increases. Each group of rows is then allocated an amount of time tₐ for receiving data sufficient for the furthest row in the group to reliably receive and store a data signal. As such, the curve 908 takes on a stepwise appearance, as shown in FIG. 9. This and similar row addressing timing schemes recognize less time savings than the first row addressing timing scheme, but are less complex, and therefore are more straightforward to implement.

In the third row addressing timing scheme, corresponding to curve 910, one of only two times are allocated to each row in the display for receiving data. All rows at a distance from the data drivers that is less than the intersection distance are allocated a time tₐ substantially equal to t_{we}. All rows located beyond the intersection distance are allocated a time tₐ substantially equal to t_{d-max}. This implementation is the most straightforward of the three to implement, but also obtains the least amount of benefit in comparison to a traditional row addressing timing scheme.

The amount of time saved, tₛₐᵥₑ, for each scheme can be calculated as follows:

$${t}_{save} = {\sum }_{r = 1}^{r = ma x} \begin{matrix}{t}_{d \text{-} ma x} - {t}_{we} , {t}_{d \text{-} prop} ( r ) < {t}_{we} \\ {t}_{d \text{-} ma x} - {t}_{a} ( r ) , {t}_{d \text{-} prop} ( r ) \geq {t}_{we}\end{matrix}$$

where tₐ(r) is the addressing time allocated by the controller to address row r, and t_{d}(r) represents the time it takes the data signal to propagate down a data line to row r. In some implementations, it is expected that in certain displays, employing a timing scheme that varies addressing time based on data propagation times will reduce addressing time by as much as about 50% or more.

As suggested above, the various row addressing timing schemes described above may be implemented by display apparatus controllers. For example, the row addressing timing schemes shown in FIG. 9 can be implemented by the timing control module 710 of the controller 700 shown in FIG. 7. In some implementations, the specific times at which the write enabling signals and data signals are to be output to each row are included as part of the output sequence stored in the schedule table store 712.

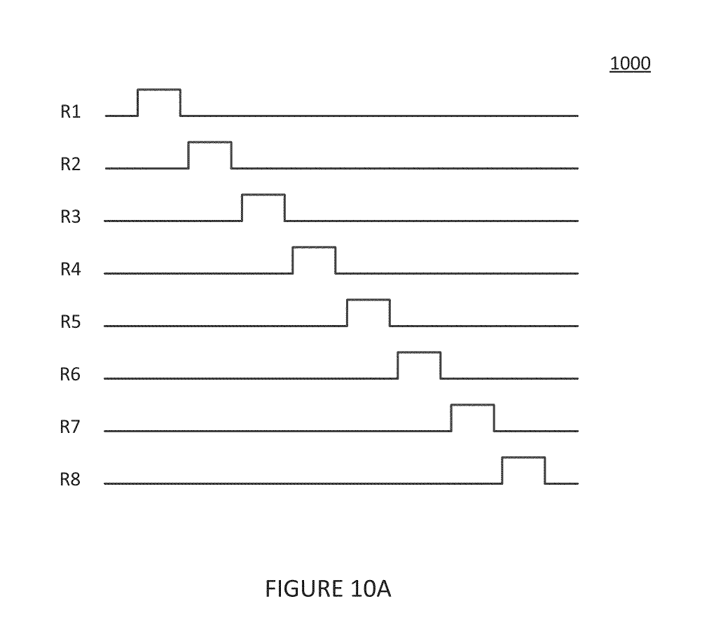

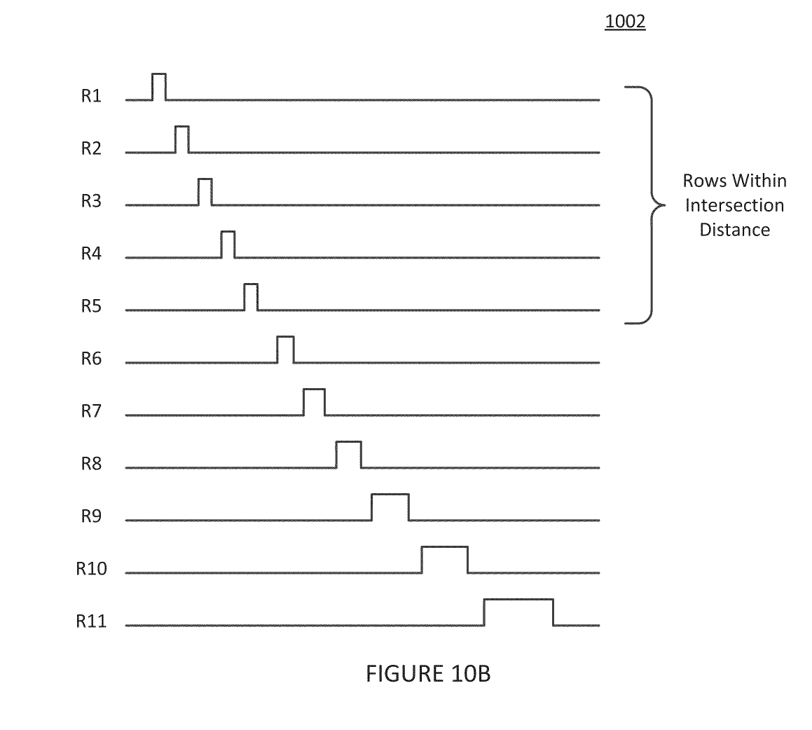

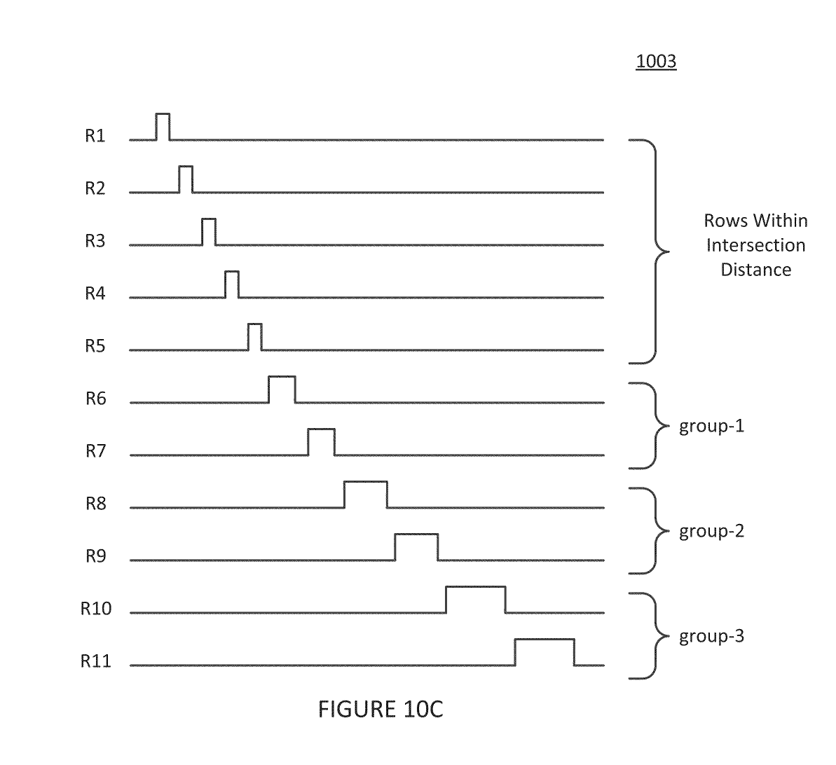

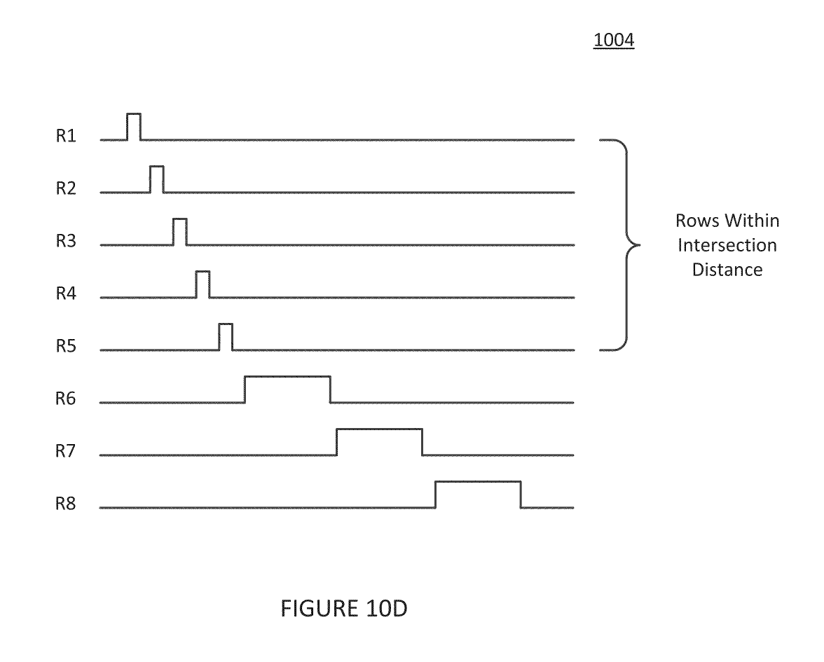

FIGS. 10A-10D show example driver output signals associated with various row addressing timing schemes. FIG. 10A shows an example set of data signals output by data drivers according to a traditional row addressing timing scheme. FIGS. 10B, 10C, and 10D show example sets of data signals output by data drivers outputting data according to row addressing timing schemes similar to that represented by curves 906, 908, and 910 depicted in FIG. 9.

When using a binary addressing scheme, data drivers output either a low signal, corresponding to a first pixel state, e.g., “ON”, or a high signal corresponding to a second pixel state, e.g., “OFF”, or visa versa. For analog light modulators, the data signal output by the driver can correspond to any number of intermediate states between ON and OFF. For illustrative purposes, each of the sets of data signals shown in FIGS. 10A-10D includes a set of only high voltage pulses. The number of rows depicted in each of FIGS. 10A-10D, along with the number of rows indicated as being within the intersection distance (described above) of a set of data drivers are selected merely for illustrative purposes. In actual implementations, a display would have many more rows within the intersection distance, as well as many more total rows. For example, a display may have from about 100 to over 2000 rows, depending on the size and resolution of the display. The number of rows within the intersection distance can vary widely from display to display. In some displays, as many as 50% of the rows of the display are beyond the intersection distance.

As indicated above, FIG. 10A shows an illustrative set of signals 1000 output by a data driver along a column of a display. In FIG. 10A, each row is allocated the same amount of time, t_{d-max}, for being addressed. That is, each row is allocated a sufficient amount time for addressing to allow the data signal to reach the last row in the display, even if the row being addressed requires far less time to receive the data signal.

FIG. 10B shows an example set of data signals 1002 output by the data drivers outputting data according to a row addressing timing scheme similar to the first row addressing timing scheme represented by curve 906 in FIG. 9. As discussed above, in the first row addressing timing scheme, the time tₐ allocated for addressing each row that is within the intersection distance is substantially equal to the scan line propagation time, t_{we}, while the time tₐ allocated for addressing each row beyond the intersection distance is substantially matched to the actual amount of time t_{d-prop} it takes for a data signal to propagate to that row. FIG. 10B shows, as an example, rows R 1-R 5 as being within the intersection distance. Because rows R1-R5 are within the intersection distance, each row is allocated the same amount of time, t_{we}, to load data into the row. For rows R6-R11, which are beyond the intersection distance, the time allocated for addressing each row increases as the distance of that row from the intersection distance increases. The increase in time substantially matches the increase in time depicted by the data propagation curve 902 shown in FIG. 9. In other words, the time tₐ allocated for addressing a row is substantially equal to the data propagation time t_{d-prop} for that row. The data propagation curve 902 increases substantially quadratically with the increase in the distance of the row from the intersection distance. Accordingly, as shown in FIG. 10B, the time allocated for each of rows R6-R11 also increases substantially quadratically.

FIG. 10C shows an example set of data signals 1003 output by the data drivers outputting data according to a row addressing timing scheme similar to the second row addressing timing scheme represented by curve 908 in FIG. 9. As discussed above, in the second row addressing timing scheme, rows located beyond the intersection distance are allocated time for addressing in groups. The times tₐ allocated for addressing each row within a particular group are equal, but the times tₐ allocated for rows in different groups increase as the distance of the group from the intersection distance increases. Similar to the example shown in FIG. 10B, FIG. 10C also shows the first five rows R1-R5 to be within the intersection distance. Thus, the times tₐ allocated for addressing rows R1-R5 are substantially equal to the scan line propagation time t_{we}. The rows R6-R11 are divided into three groups of two rows each. The rows R6 and R7 are grouped in Group 1, the rows R8 and R9 are grouped in Group 2, and the rows R10 and R11 are grouped in Group 3. The time tₐ allocated for addressing each row within each group remains equal. Therefore, the times tₐ allocated for addressing the rows R6 and R7 in Group 1 are equal. Similarly, the times tₐ allocated for addressing the rows R8 and R9 in Group 2 are equal, and the times tₐ allocated for addressing the rows R10 and R11 in Group 3 are equal. However, because the time allocated for addressing rows in each group increases as the distance of the group from the intersection distance increases, the time allocated for addressing a row (e.g., row R10) in Group 3 is larger than the time allocated for addressing a row (e.g., row R9) in Group 2. Similarly, the time allocated for addressing a row (e.g., row R8) in Group 2 is larger than the time allocated for addressing a row (e.g., row R7) in Group 1.

It is understood that the number of groups and the number of rows in each group shown in FIG. 10B is only one example of many possibilities. For example, the number of groups can be equal to two instead of three, where rows R6-R8 are in one group and rows R9-R11 are in another group. Alternatively, rows can be grouped into more than three groups. The number of rows within each group can also be unequal, and vary, for instance, as a function of the distance of that group from the intersection distance. For example, rows R6-R8 can belong to a first group, rows R9-R10 can belong to the second group, and row R11 can belong to the third group.

FIG. 10D shows an example set of data signals 1004 output by the data drivers outputting data according to a row addressing timing scheme similar to the third row addressing timing scheme represented by curve 910 in FIG. 9. As discussed above, in the third row addressing timing scheme, the rows located from the data drivers at a distance that is less than the intersection distance are allocated a time tₐ substantially equal to the scan line propagation time, t_{we}, while the rows located beyond the intersection distance are allocated a time tₐ substantially equal to the maximum data propagation time t_{d-max}. Similar to the example shown in FIGS. 10B and 10C, FIG. 10D also shows the rows R1-R5 as being within the intersection distance. Thus, the time tₐ allocated for addressing the rows R1-R5 is substantially equal to the scan line propagation time, t_{we}. However, the remaining rows, R6-R 8, which are located beyond the intersection distance, are allocated time tₐ that is substantially equal to the maximum data propagation time t_{d-max}.

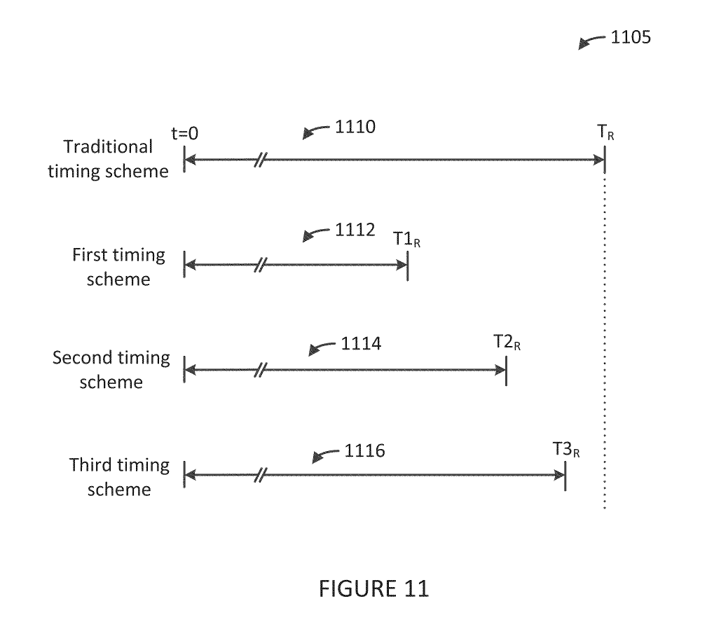

FIG. 11 shows a chart 1105 comparing the time allocated for addressing a set of rows according to various row addressing timing schemes. The chart 1105 includes four timelines, timelines 1110, 1112, 1114, and 1116, each representing the total time allocated for addressing R rows of a display according to the traditional row addressing timing scheme, the first row addressing timing scheme, the second row addressing timing scheme, and the third row addressing timing scheme, respectively.

The timeline 1110 corresponds to the traditional row addressing timing scheme. The time T_{R} represents the total time allocated for addressing each of the R rows using the traditional row addressing timing scheme. Timeline 1112 corresponds to the first row addressing timing scheme shown in FIG. 10B. As discussed above, the first row addressing timing scheme allocates time for addressing each row beyond the intersection distance to be substantially equal to the data propagation time necessary for the data signal to reach the row. This timing scheme provides considerable time saving as depicted in the time line 1112, in which the time T1_{R} allocated to address the same number, R, of rows is considerably less than that (T_{R}) allocated for addressing R rows in the traditional timing scheme. In some implementations, T1_{R} may be as little as, or less than, about 50% of the T_{R}. The timeline 1114 corresponds to the second row addressing timing scheme described above. As shown in the timeline 1114, the time, T2_{R}, allocated to address R rows using the second row addressing timing scheme is greater than the time allocated for addressing the same number of rows using the first timing scheme. However, the addressing time allocated when using the second row addressing timing scheme T2_{R} is still less than that allocated when using the traditional timing scheme. The time T2_{R} can be further reduced by increasing the number of groups of rows used in the scheme and by reducing the number of rows allocated to each group. Finally, the timeline 1116 shows the time, T3_{R}, allocated to address R rows of a display according to the third row addressing timing scheme described above. Time T3_{R}, while greater than T1_{R} and T2_{R}, is still less than T_{R}.

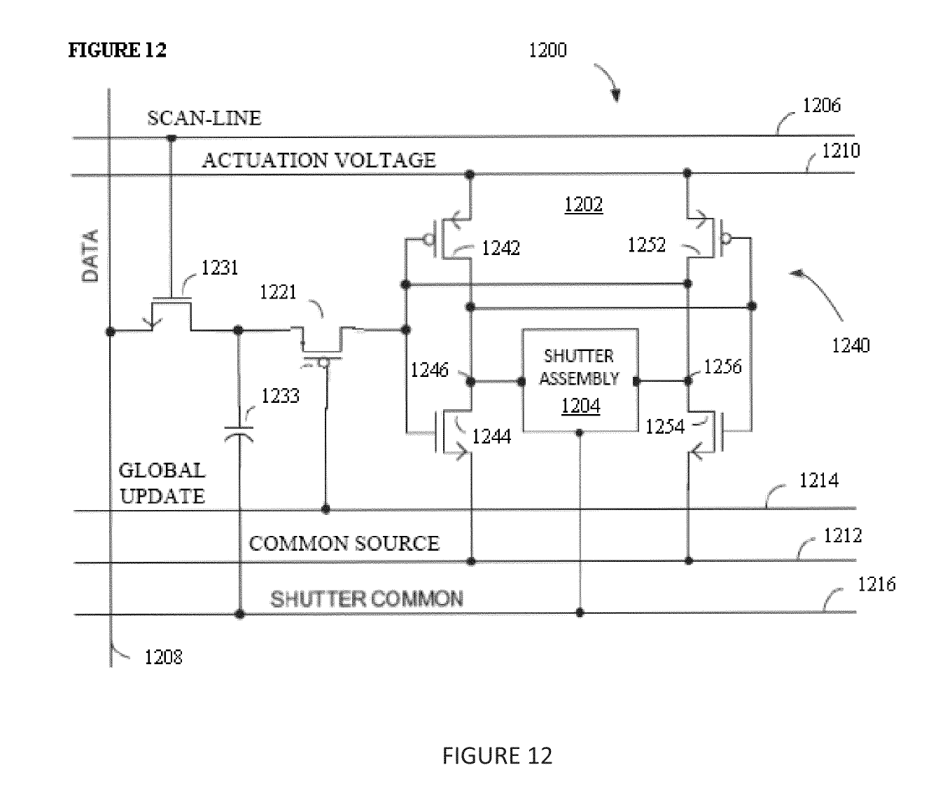

FIG. 12 shows a portion of one example control matrix 1200. The control matrix 1200 can be implemented for use in the display apparatus 100 depicted in FIG. 1A. The timing of various signals applied to the control matrix 1200 can be controlled according to the data loading and row addressing timing schemes discussed herein. The structure of the control matrix 1200 is described immediately below.

The control matrix 1200 controls an array of pixels 1202 that includes light modulators having dual-actuator shutter assemblies 1204. The actuators in the shutter assemblies 1204 can be made either electrically bi-stable or mechanically bi-stable.

The control matrix 1200 includes a scan-line interconnect 1206 for each row of pixels 1202 in the display apparatus 100 and a data interconnect 1208 for each column of pixels 1202. The scan-line interconnect 1206 is configured to allow data to be loaded onto the pixel 1202. The data interconnect 1208 is configured to provide a data voltage corresponding to the data to be loaded on to the pixel 1202. Further, the control matrix 1200 includes an actuation voltage interconnect 1210, a common source interconnect 1212, a global update interconnect 1214 and a shutter common interconnect 1222 (collectively referred to as “common interconnects”). These common interconnects 1210, 1212, 1214 and 1216 are shared among pixels 1202 in multiple rows and multiple columns in the array. In some implementations, the common interconnects 1210, 1212, 1214 and 1216 are shared among all pixels 1202 in the display apparatus 100. These interconnects are configured to latch the pixel 1202 to one of a first state and a second opposite state by actuating the shutter assembly 1204 of the pixel 1202.

Each pixel 1202 in the control matrix 1200 also includes a write-enable transistor 1231 and a data store capacitor 1233. The gate of the write-enable transistor 1231 is coupled to the scan-line interconnect 1206 such that the scan-line interconnect 1206 controls the write-enable transistor 1231. The source of the write-enable transistor 1231 is coupled to the data interconnect 1208 and the drain of the write-enable transistor 1231 is coupled to a first terminal of the data store capacitor 1233 and an update transistor 1221 described below. A second terminal of the data store capacitor 1233 is coupled to the shutter common interconnect 1216. In this way, as the write-enable transistor 1231 is switched on via a write-enabling voltage provided by the scan-line interconnect 1206, a data voltage provided by the data interconnect 1208 passes through the write-enable transistor 1231 and is stored at the data store capacitor 1233. The stored data voltage is then used to latch the pixel 1202 to one of a first pixel state or second pixel state.

The pixel 1202 includes a latch circuit 1240 that includes a first shutter-state inverter and a second shutter-state inverter. The first shutter-state inverter includes a first charge transistor 1242 and a first discharge transistor 1244. The second shutter-state inverter includes a second charge transistor 1252 and a second discharge transistor 1254. The first shutter-state inverter and the second shutter-state inverter are cross-coupled such that the inputs of the first shutter-state inverter are coupled to the outputs of the second shutter-state inverter and vice versa. In this way, the first shutter-state inverter and the second shutter-state inverter together operate as a latch or a flip flop circuit.

The gates of the first charge transistor 1242 and the first discharge transistor 1244 are coupled to the drains of the second charge transistor 1252 and the second discharge transistor 1254, while the gates of the second charge transistor 1252 and the second discharge transistor 1254 are coupled to the drains of the first charge transistor 1242 and the first discharge transistor 1244. The drain of the first charge transistor 1242 connects to the drain of first discharge transistor 1244 at a first shutter-state node 1246. The drain of second charge transistor 1252 connects to the drain of second discharge transistor 1254 at a second shutter-state node 1256. As such, the first shutter-state node 1246 controls the gate voltage of both the first charge transistor 1252 and the second discharge transistor 1254 of the second shutter-state inverter and the second shutter-state node 1256 controls the gate voltage of both of the first charge transistor 1242 and the first discharge transistor 1244 of the first shutter-state inverter. The source terminals of the first charge transistor 1242 and the second charge transistor 1252 are coupled to the actuation voltage interconnect 1210. The source terminals of the first discharge transistor 1244 and the second discharge transistor 1254 are coupled to the common source interconnect 1212.

The dual-actuator shutter assembly 1204 of the pixel 1202 includes a first shutter-state actuator that is coupled to the first shutter-state node 1246 and a second shutter-state actuator that is coupled to the second shutter-state node 1256. A reference electrode of the shutter assembly 1204 is coupled to the shutter common interconnect 1216. In some implementations, when the voltage at the first shutter-state node 1246 is substantially higher than the voltage at the reference electrode, the shutter assembly 1204 and the pixel 1202 are in the first state. Conversely, when the voltage at the second shutter-state node 1256 is substantially higher than the voltage at the reference electrode, the shutter assembly 1204 and the pixel 1202 are in the second state.

The pixel 1202 further includes the update transistor 1221 that couples the data store capacitor 1233 to the latch circuit 1240. The update transistor 1221 is a pMOS transistor. The update transistor 1221 is configured to electrically isolate the voltage on the data store capacitor 1233 from voltages on the latch circuit 1240. Specifically, the source of the update transistor 1221 is coupled to the first terminal of the data store capacitor 1233 and the drain of the write-enable transistor 1231. The gate of the update transistor 1221 is coupled to the global update interconnect 1214 and the drain of the update transistor 1221 is coupled to the first charging transistor 1242 and the first discharging transistor 1244 of the latch circuit 1240.

The control matrix 1200 makes use of two complementary types of transistors, both pMOS and nMOS transistors. It is therefore referred to as a complementary metal-oxide semiconductor (CMOS) control matrix. The update transistor 1221 and the charging transistors 1242 and 1252, for example, are pMOS transistors, while the discharge transistors 1244 and 1254, among others, are nMOS transistors. In other implementations, the types of transistors employed in control matrix 1200 can be reversed. For example, nMOS transistors can be used for the charging transistors and pMOS transistors can be used for the discharge transistors. Likewise, the update transistor 1221 can be implemented with an nMOS transistor in some other implementations. In particular, the nMOS transistor may be coupled to the actuation voltage interconnect 1210 via an inverter, or to another interconnect. In some implementations, each of the transistors referred to above is implemented as a thin-film transistor, based on, e.g., amorphous-silicon or poly-silicon transistor architectures.

The control matrix 1200 is only one example of a wide variety of control matrices that may be employed to control the pixels of the display apparatus disclosed herein. In some other implementations, various other control matrix architectures are employed, including those that can be implemented solely with nMOS transistors and thus are more amenable to being implemented using metal oxide transistor architectures, as well as amorphous-silicon or poly-silicon transistor architectures.

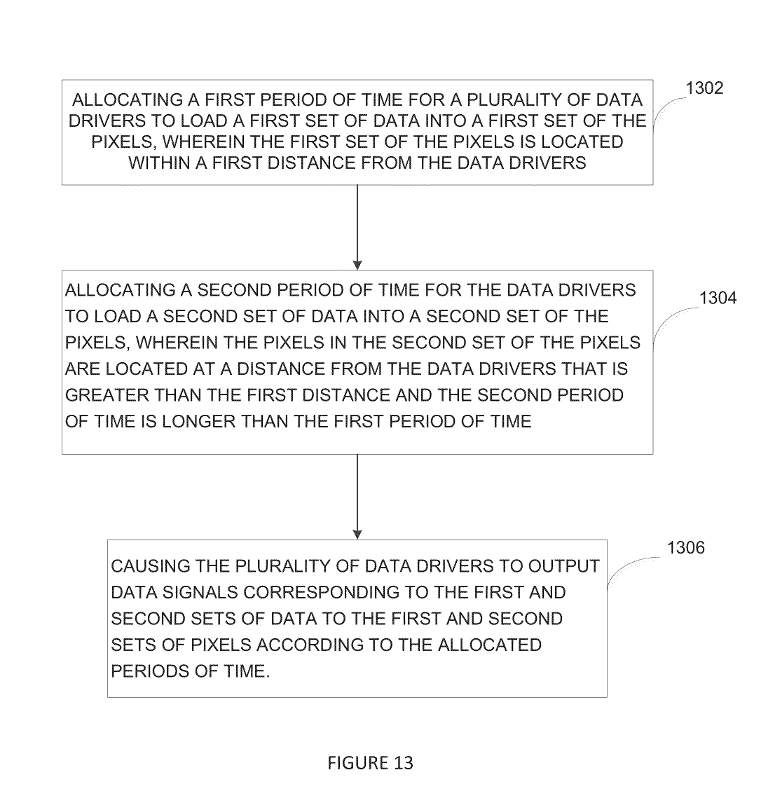

FIG. 13 shows a flow diagram of one implementation of a method 1300 of forming an image on a display. The method 1300 corresponds to the row addressing timing schemes set forth above in which different amounts of time are allocated for addressing different rows of a display. More particularly, the method 1300 includes allocating a first period of time for a plurality of data drivers to load a first set of data into a first set of the pixels (stage 1302), allocating a second period of time for the data drivers to load a second set of data into a second set of the pixels (stage 1304), and causing the plurality of data drivers to output data signals correspond to the first and second sets of data to the first and second sets of pixels according to the allocated periods of time (stage 1306).

As set forth above, a first period of time, such as the amount of time it takes for a write-enabling voltage to propagate across a row of a display, t_{we}, is allocated to a first set of pixels (stage 1302). In some implementations, the first set of pixels include rows of pixels located within the intersection distance from the data drivers of the display. The first set of data is indicative of subsequent states of the pixels in the first set of pixels.

A second period of time is allocated to the data drivers for loading a second set of data into a second set of pixels (stage 1304). The second set of data is indicative of subsequent states of the pixels in the second set of pixels. In some implementations, the second set of pixels includes pixels in rows that are further from the data drivers than the intersection distance of the display. That is, the second set of pixels are located a greater distance from the data drivers than the first set of pixels. In some implementations, further time allocations can be made for additional sets of pixels located further from the data drivers.

Based on the allocated times, the data drivers then output data signals indicative of the first and second data sets to the first and second sets of pixels (stage 1306).

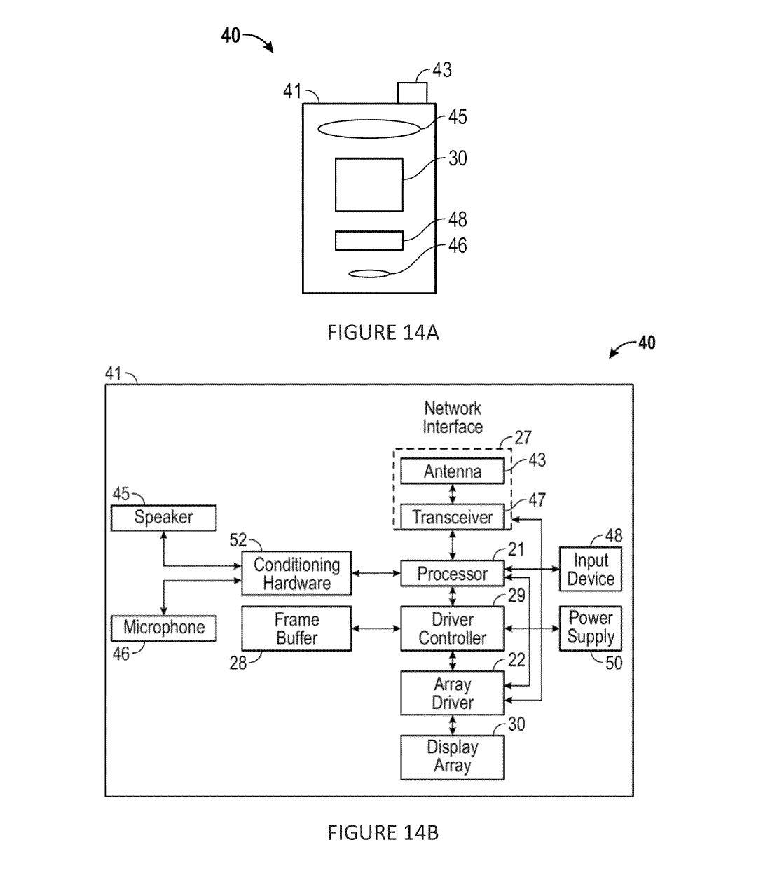

FIGS. 14A and 14B are system block diagrams illustrating a display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 14A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 14A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
an array of pixels formed on a substrate;
a plurality of data drivers configured to output data signals to the pixels, wherein the data signals are representative of subsequent states of each respective pixel; and
a controller configured to:
allocate a first period of time for the data drivers to load data into a first set of the pixels, wherein the first set of the pixels is located within a first distance from the data drivers, and
allocate a second period of time for the data drivers to load data into a second set of the pixels, wherein the pixels in the second set of the pixels are located at a distance from the data drivers that is greater than the first distance, and the second period of time is longer than the first period of time.

2. The apparatus of claim 1, wherein the data signals output by the data drivers are applied to at least one thin film transistor associated with each of the pixels.

3. The apparatus of claim 1, wherein the array of pixels includes at least one of an array of transmissive light modulators, an array of reflective light modulators, and an array of light emitters.

4. The apparatus of claim 1, wherein the array of pixels includes an array of electromechanical system (EMS) based light modulators.

5. The apparatus of claim 1, wherein the array of pixels includes an array of shutter-based light modulators.

6. The apparatus of claim 1, wherein the first set of the pixels includes at least a first row of pixels and the second set of the pixels includes at least a second row of pixels.

7. The apparatus of claim 1, wherein the controller is further configured to cause the data drivers to output data signals to the first set of the pixels for the first period of time and instruct the data drivers to output data signals to the second set of the pixels for the second period of time.

8. The apparatus of claim 1, further comprising a plurality of scan-line drivers configured to output write-enabling signals to the pixels, wherein the controller is further configured to cause the scan-line drivers to output write-enabling signals to the second set of the pixels for a greater amount of time than the time for which write-enabling signals are output by the scan-line drivers to the first set of the pixels.

9. The apparatus of claim 8, wherein:
the first distance is sufficiently short enough such that the data signals output by the data drivers reach the first set of the pixels before the write-enabling signals reach a pixel in the first set of the pixels furthest from the scan-line drivers, and
the second set of pixels are located sufficiently far enough from the data drivers such that the data signals output by the data drivers first reach the second set of the pixels after the write-enabling signals reach a pixel in the second set of the pixels furthest from the scan-line drivers.

10. The apparatus of claim 1, wherein the controller is configured to individually allocate periods of time to each row of pixels located at distances from the data drivers that is greater than the first distance.

11. The apparatus of claim 1, wherein the controller is configured to allocate periods of time to row of pixels located at distances from the data drivers that is greater than the first distance in groups.

12. The apparatus of claim 1, wherein the controller allocates increasing periods of time to each group of rows that is more distant from the data driver than the first distance.

13. The apparatus of claim 1, wherein the controller is further configured to cause the data drivers to output data signals to the second set of the pixels by allocating a maximum data propagation time to pixels in all rows in which the amount of time it takes for a data signal to propagate to a row being addressed is greater than the amount of time it takes for a write-enabling signal to propagate to the end of that row.

14. The display apparatus of claim 1, wherein the first distance is substantially equal to the distance a data signal output by the data drivers travels in the amount of time it takes for a write enabling signal output by a scan-line driver to reach the end of a row of pixels.

15. The apparatus of claim 1, further comprising:
a display module incorporating the array of pixels and the controller;
a processor configured to process image data; and
a memory device that is configured to communicate with the processor.

16. The apparatus of claim 15, wherein the controller comprises at least one of the processor and the memory device.

17. The apparatus of claim 15, further comprising:
a display driver circuit configured to send at least one signal to the display module; and wherein
the processor is further configured to send at least a portion of the image data to the display driver circuit.

18. The apparatus of claim 15, further comprising:
an image source module configured to send the image data to the processor, wherein the image source module comprises at least one of a receiver, transceiver, and transmitter.

19. The apparatus of claim 15, further comprising:
an input device configured to receive input data and to communicate the input data to the processor.

20. A method of forming an image on a display, comprising:
allocating a first period of time for a plurality of data drivers to load a first set of data into a first set of pixels, wherein the first set of pixels is located within a first distance from the data drivers and the first set of data is indicative of subsequent states of the first set of pixels;
allocating a second period of time for the data drivers to load a second set of data into a second set of pixels, wherein the pixels in the second set of pixels are located at a distance from the data drivers that is greater than the first distance, the second period of time is longer than the first period of time, and the second set of data is indicative of subsequent states of the second set of pixels; and
causing the plurality of data drivers to output data signals corresponding to the first and second sets of data to the first and second sets of pixels according to the allocated periods of time.

21. The method of claim 20, wherein the array of pixels includes an array of electromechanical system (EMS) based light modulators.

22. The method of claim 20, wherein the first set of pixels includes at least a first row of pixels and the second set of pixels includes at least a second row of pixels.

23. The method of claim 20, wherein the first distance is substantially equal to the distance a data signal output by the data drivers travels in the amount of time it takes for a write enabling signal output by a write enabling driver to reach the end of a row of pixels.

24. A computer-readable storage medium having computer-executable instructions stored thereon, which when executed by a computer, cause the computer to:
allocate a first period of time for a plurality of data drivers to load a first set of data into a first set of pixels, wherein the first set of pixels is located within a first distance from the data drivers and the first set of data is indicative of subsequent states of the first set of pixels;
allocate a second period of time for the data drivers to load a second set of data into a second set of pixels, wherein the pixels in the second set of pixels are located at a distance from the data drivers that is greater than the first distance, the second period of time is longer than the first period of time, and the second set of data is indicative of subsequent states of the second set of pixels; and
cause the plurality of data drivers to output data signals corresponding to the first and second sets of data to the first and second sets of pixels according to the allocated periods of time.

25. The method of claim 24, wherein the array of pixels includes an array of electromechanical system (EMS) based light modulators.

26. The method of claim 24, wherein the first set of pixels includes at least a first row of pixels and the second set of pixels includes at least a second row of pixels.

27. The method of claim 24, wherein the first distance is substantially equal to the distance a data signal output by the data drivers travels in the amount of time it takes for a write enabling signal output by a write enabling driver to reach the end of a row of pixels.
